(19) United States
(12) Patent Application Publication
(10) Pub. No.: US 2026/0012647 A1
(43) Pub. Date: Jan. 8, 2026

(54) USAGES OF CONSTITUENT RECTANGLES

(71) Applicant: Nokia Technologies Oy, Espoo (FI)

(72) Inventors: Jill BOYCE, Portland, OR (US); Miska Matias HANNUKSELA, Tampere (FI)

(21) Appl. No.: 19/259,170

(22) Filed: Jul. 3, 2025

Related U.S. Application Data
(60) Provisional application No. 63/667,892, filed on Jul. 5, 2024.

(51) Int. Cl. H04N 19/70; H04N 19/30; H04N 19/597

(52) U.S. Cl. CPC H04N 19/70; H04N 19/30; H04N 19/597

(57) ABSTRACT

Various embodiments provide methods, apparatuses, and computer program products. An example apparatus includes: at least one processor; and at least one memory storing instructions that, when executed by the at least one processor, cause the apparatus at least to perform: signaling a constituent rectangle information message without the value of the identifier of the constituent rectangle; and wherein when the value of the identifier is not present in the constituent rectangle information message, the value of the identifier is inferred to be equal to a value of a previously signaled identifier plus a first value.

### TECHNICAL FIELD

The examples and non-limiting embodiments relate generally to multimedia transport and, more particularly to, usages of constituent rectangles in a coded video.

### BACKGROUND

It is known to perform data compression and data decompression in a multimedia system.

### SUMMARY

Example 1: An apparatus comprising: at least one processor; and at least one memory storing instructions that, when executed by the at least one processor, cause the apparatus at least to perform: signaling a constituent rectangle information message without the value of the identifier of the constituent rectangle; and wherein when the value of the identifier is not present in the constituent rectangle information message, the value of the identifier is inferred to be equal to a value of a previously signaled identifier plus a first value. In an example, the first value is equal to 1.

Example 2: The apparatus of example 1, wherein when an index of the constituent rectangle is equal to zero, the value of the identifier is inferred to be equal to 0.

Example 3: The apparatus of any of the examples 1 or 2, wherein the apparatus is further caused to perform: signaling an associated constituent rectangle identifier within the constituent rectangle information message for associating a second constituent rectangle with the constituent rectangle.

Example 4: The apparatus of example 3, wherein the apparatus is further caused perform: signaling an enable flag; signaling, when the enable flag is set to a second value, a presence flag for the constituent rectangle, wherein the associated constituent rectangle identifier is signaled when the presence flag is set to a third value. In an example, the second and third values are equal to 1.

Example 5: The apparatus of any of the previous examples, wherein the apparatus is further caused to perform: defining a group identifier; and signaling the group identifier within the constituent rectangle information message for providing a capability to group two or more constituent rectangles sharing same value for the group identifier.

Example 6: The apparatus of example 5, wherein each constituent rectangle of the two or more constituent rectangles comprises a unique value of the identifier.

Example 7: The apparatus of any of the previous examples, the apparatus is further caused to perform: defining a constituent rectangle nesting information message for providing a mechanism for associating a list of information messages with a set of constituent rectangles, wherein the constituent rectangle nesting information message comprises one or more information messages.

Example 8: The apparatus of example 7, wherein the constituent rectangle nesting information message comprises syntax to indicate the set of constituent rectangles for which the list of constituent rectangle information messages applies.

Example 9: The apparatus of any of the examples 7 or 8, wherein the constituent rectangle nesting information message is comprised in a current picture unit, when the constituent rectangle information message is comprised in the current picture unit or in a picture unit that precedes the current picture unit in decoding order within a current coded layer video sequence.

Example 10: The apparatus of any of examples 7 or 8, wherein the apparatus is further caused to perform: specifying following variables for interpretation of the constituent rectangle nesting information message: nested layers variables for identifying nested layers; and/or a syntax structure for signaling contents of the constituent rectangle nesting information message.

Example 11: The apparatus of example 10, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 12: The apparatus of any of the examples 10 or 11, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 13: The apparatus of example 12, wherein the syntax structure comprises a constituent rectangle nesting information message byte field comprising a first index and a second index for specifying a byte corresponding to first index of a constituent rectangle nesting information message corresponding to the second index.

Example 14: An apparatus comprising: at least one processor; and at least one memory storing instructions that, when executed by the at least one processor, cause the apparatus at least to perform: signaling a constituent rectangle information message; defining an associated constituent rectangle identifier; and signaling the associated constituent rectangle identifier within the constituent rectangle information message for associating a second constituent rectangle with the constituent rectangle.

Example 15: The apparatus of example 14, wherein when a depth representation information message applies to a current picture, the associated constituent rectangle identifier indicates the primary constituent rectangle associated with a constituent rectangle of type depth.

Example 16: The apparatus of example 14, wherein when the alpha channel information message applies to a current picture, the associated constituent rectangle identifier indicates the primary constituent rectangle associated with constituent rectangle of type alpha to provide information about alpha channel sample values and post-processing applied to the decoded alpha planes coded in a constituent rectangle of type alpha and the associated constituent rectangle.

Example 17: An apparatus comprising: at least one processor; and at least one memory storing instructions that, when executed by the at least one processor, cause the apparatus at least to perform: defining a group identifier; signaling a constituent rectangle information message; and signaling the group identifier within the constituent rectangle information message for providing a capability to group two or more constituent rectangles sharing same value for the group identifier.

Example 18: The apparatus of example 17, wherein when the multiview acquisition information message is present, the group identifier indicates a view identifier or determines which constituent rectangles that the parameters signaled in the multiview acquisition information message apply to.

Example 19: An apparatus comprising: at least one processor; and at least one memory storing instructions that, when executed by the at least one processor, cause the apparatus at least to perform: defining a constituent rectangle nesting information message for providing a mechanism for associating a list of information messages with a set of constituent rectangles; wherein the constituent rectangle nesting information message comprises one or more information messages; and signaling the constituent rectangle nesting information message.

Example 20: The apparatus of example 19, wherein the constituent rectangle nesting information message comprises syntax to indicate the set of constituent rectangles for which the list of constituent rectangle information messages applies.

Example 21: The apparatus of any of the examples 19 or 20, wherein the constituent rectangle nesting information message is comprised in a current picture unit, when the constituent rectangle information message is comprised in the current picture unit or in a picture unit that precedes the current picture unit in decoding order within a current coded layer video sequence.

Example 22: The apparatus of any of examples 19 or 20, wherein the apparatus is further caused to perform: specifying following variables for interpretation of the constituent rectangle nesting information message: nested layers variables for identifying nested layers; and/or a syntax structure for signaling contents of the constituent rectangle nesting information message.

Example 23: The apparatus of example 22, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 24: The apparatus of any of the examples 22 or 23, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 25: The apparatus of example 24, wherein the syntax structure comprises a constituent rectangle nesting information message byte field comprising a first index and a second index for specifying a byte corresponding to first index of a constituent rectangle nesting information message corresponding to the second index.

Example 26: An apparatus comprising: at least one processor; and at least one memory storing instructions that, when executed by the at least one processor, cause the apparatus at least to perform: receiving a constituent rectangle information message without a value of the identifier of the constituent rectangle; inferring the value of the identifier to be equal to a value of a previously signaled identifier plus a first value; and determining the constituent rectangle based on the inferring.

Example 27: The apparatus of example 26, wherein when an index of the constituent rectangle is equal to zero, the value of the identifier is inferred to be equal to 0.

Example 28: The apparatus of any of the examples 26 or 27, wherein the apparatus is further caused to perform: receiving an associated constituent rectangle identifier within the constituent rectangle information message for associating a second constituent rectangle with the constituent rectangle.

Example 29: The apparatus of example 28, wherein the apparatus is further caused perform: receiving an enable flag; receiving, when the enable flag is set to a second value, a presence flag for the constituent rectangle, wherein the associated constituent rectangle identifier is received when the presence flag is set to a third value.

Example 30: The apparatus of any of the examples 26 to 29, wherein the apparatus is further caused to perform: receiving a group identifier within the constituent rectangle information message, wherein the group identifier provides a capability to group two or more constituent rectangles sharing same value for the group identifier.

Example 31: The apparatus of example 30, wherein each constituent rectangle of the two or more constituent rectangles comprises a unique value of the identifier.

Example 32: The apparatus of any of the examples 26 to 31, the apparatus is further caused to perform: receiving a constituent rectangle nesting information message, wherein the constituent rectangle nesting information message provides a mechanism for associating a list of information messages with a set of constituent rectangles, wherein the constituent rectangle nesting information message comprises one or more information messages.

Example 33: The apparatus of example 32, wherein the constituent rectangle nesting information message comprises syntax to indicate the set of constituent rectangles for which the list of constituent rectangle information messages applies.

Example 34: The apparatus of any of the examples 32 or 33, wherein the constituent rectangle nesting information message is comprised in a current picture unit, when the constituent rectangle information message is comprised in the current picture unit or in a picture unit that precedes the current picture unit in decoding order within a current coded layer video sequence.

Example 35: The apparatus of any of examples 32 or 33, wherein the apparatus is further caused to perform: receiving following variables for interpretation of the constituent rectangle nesting information message: nested layers variables for identifying nested layers; and/or a syntax structure for receiving contents of the constituent rectangle nesting information message.

Example 36: The apparatus of example 35, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 37: The apparatus of any of the examples 35 or 36, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 38: The apparatus of example 37, wherein the syntax structure comprises a constituent rectangle nesting information message byte field comprising a first index and a second index for specifying a byte corresponding to first index of a constituent rectangle nesting information message corresponding to the second index.

Example 39: An apparatus comprising: at least one processor; and at least one memory storing instructions that, when executed by the at least one processor, cause the apparatus at least to perform: receiving a constituent rectangle information message; and receiving an associated constituent rectangle identifier within the constituent rectangle information message, wherein the associated constituent rectangle identifier is used for associating a second constituent rectangle with the constituent rectangle.

Example 40: The apparatus of example 39, wherein when a depth representation information message applies to a current picture, the associated constituent rectangle identifier indicates the primary constituent rectangle associated with a constituent rectangle of type depth.

Example 41: The apparatus of example 39, wherein when an alpha channel information message applies to a current picture, the associated constituent rectangle identifier indicates the primary constituent rectangle associated with constituent rectangle of type alpha to provide information about alpha channel sample values and post-processing applied to the decoded alpha planes coded in a constituent rectangle of type alpha and the associated constituent rectangle.

Example 42: An apparatus comprising: at least one processor; and at least one memory storing instructions that, when executed by the at least one processor, cause the apparatus at least to perform: receiving a constituent rectangle information message; and receiving a group identifier within the constituent rectangle information message to provide a capability to group two or more constituent rectangles sharing same value for the group identifier.

Example 43: The apparatus of example 42, wherein when a multiview acquisition information message is present, the group identifier indicates a view identifier or determines which constituent rectangles that the parameters signaled in the multiview acquisition information message apply to.

Example 44: An apparatus comprising: at least one processor; and at least one memory storing instructions that, when executed by the at least one processor, cause the apparatus at least to perform: receiving a constituent rectangle nesting information message, wherein constituent rectangle nesting information message provides a mechanism for associating a list of information messages with a set of constituent rectangles; and wherein the constituent rectangle nesting information message comprises one or more information messages.

Example 45: The apparatus of example 44, wherein the constituent rectangle nesting information message comprises syntax to indicate the set of constituent rectangles for which the list of constituent rectangle information messages applies.

Example 46: The apparatus of any of the examples 44 or 45, wherein the constituent rectangle nesting information message is comprised in a current picture unit, when the constituent rectangle information message is comprised in the current picture unit or in a picture unit that precedes the current picture unit in decoding order within a current coded layer video sequence.

Example 47: The apparatus of any of examples 44 or 45, wherein following variables are specified for interpretation of the constituent rectangle nesting information message: nested layers variables for identifying nested layers; and/or a syntax structure for signaling contents of the constituent rectangle nesting information message.

Example 48: The apparatus of example 47, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 49: The apparatus of any of the examples 47 or 48, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 50: The apparatus of example 49, wherein the syntax structure comprises a constituent rectangle nesting information message byte field comprising a first index and a second index for specifying a byte corresponding to first index of a constituent rectangle nesting information message corresponding to the second index.

Example 51: A method comprising: signaling a constituent rectangle information message without the value of the identifier of the constituent rectangle; and wherein when the value of the identifier is not present in the constituent rectangle information message, the value of the identifier is inferred to be equal to a value of a previously signaled identifier plus a first value.

Example 52: The method of example 51, wherein when an index of the constituent rectangle is equal to zero, the value of the identifier is inferred to be equal to 0.

Example 53: The method of any of the examples 51 or 52 further comprising: signaling an associated constituent rectangle identifier within the constituent rectangle information message for associating a second constituent rectangle with the constituent rectangle.

Example 54: The method of example 53 further comprising: signaling an enable flag; signaling, when the enable flag is set to a second value, a presence flag for the constituent rectangle, wherein the associated constituent rectangle identifier is signaled when the presence flag is set to a third value.

Example 55: The method of any of the examples 51 to 54 further comprising: defining a group identifier; and signaling the group identifier within the constituent rectangle information message for providing a capability to group two or more constituent rectangles sharing same value for the group identifier.

Example 56: The method of example 55, wherein each constituent rectangle of the two or more constituent rectangles comprises a unique value of the identifier.

Example 57: The method of any of the examples 51 to 56 further comprising: defining a constituent rectangle nesting information message for providing a mechanism for associating a list of information messages with a set of constituent rectangles, wherein the constituent rectangle nesting information message comprises one or more information messages.

Example 58: The method of example 57, wherein the constituent rectangle nesting information message comprises syntax to indicate the set of constituent rectangles for which the list of constituent rectangle information messages applies.

Example 59: The method of any of the examples 57 or 88, wherein the constituent rectangle nesting information message is comprised in a current picture unit, when the constituent rectangle information message is comprised in the current picture unit or in a picture unit that precedes the current picture unit in decoding order within a current coded layer video sequence.

Example 60: The method of any of examples 57 or 58 further comprising: specifying following variables for interpretation of the constituent rectangle nesting information message: nested layers variables for identifying nested layers; and/or a syntax structure for signaling contents of the constituent rectangle nesting information message.

Example 61: The method of example 60, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 62: The method of any of the examples 60 or 61, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 63: The method of example 62, wherein the syntax structure comprises a constituent rectangle nesting information message byte field comprising a first index and a second index for specifying a byte corresponding to first index of a constituent rectangle nesting information message corresponding to the second index.

Example 64: A method comprising: signaling a constituent rectangle information message; defining an associated constituent rectangle identifier; and signaling the associated constituent rectangle identifier within the constituent rectangle information message for associating a second constituent rectangle with the constituent rectangle.

Example 65: The method of example 64, wherein when a depth representation information message applies to a current picture, the associated constituent rectangle identifier indicates the primary constituent rectangle associated with a constituent rectangle of type depth.

Example 66: The method of example 64, wherein when the alpha channel information message applies to a current picture, the associated constituent rectangle identifier indicates the primary constituent rectangle associated with constituent rectangle of type alpha to provide information about alpha channel sample values and post-processing applied to the decoded alpha planes coded in a constituent rectangle of type alpha and the associated constituent rectangle.

Example 67: A method comprising: defining a group identifier; and signaling a constituent rectangle information message; and signaling the group identifier within the constituent rectangle information message for providing a capability to group two or more constituent rectangles sharing same value for the group identifier.

Example 68: The method of example 67, wherein when the multiview acquisition information message is present, the group identifier indicates a view identifier or determines which constituent rectangles that the parameters signaled in the multiview acquisition information message apply to.

Example 69: A method comprising: defining a constituent rectangle nesting information message for providing a mechanism for associating a list of information messages with a set of constituent rectangles; wherein the constituent rectangle nesting information message comprises one or more information messages; and signaling the constituent rectangle nesting information message.

Example 70: The method of example 69, wherein the constituent rectangle nesting information message comprises syntax to indicate the set of constituent rectangles for which the list of constituent rectangle information messages applies.

Example 71: The method of any of the examples 69 or 70, wherein the constituent rectangle nesting information message is comprised in a current picture unit, when the constituent rectangle information message is comprised in the current picture unit or in a picture unit that precedes the current picture unit in decoding order within a current coded layer video sequence.

Example 72: The method of any of examples 69 or 70 further comprising: specifying following variables for interpretation of the constituent rectangle nesting information message: nested layers variables for identifying nested layers; and/or a syntax structure for signaling contents of the constituent rectangle nesting information message.

Example 73: The method of example 72, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 74: The method of any of the examples 72 or 73, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 75: The method of example 74, wherein the syntax structure comprises a constituent rectangle nesting information message byte field comprising a first index and a second index for specifying a byte corresponding to first index of a constituent rectangle nesting information message corresponding to the second index.

Example 76: A method comprising: receiving a constituent rectangle information message without a value of the identifier of the constituent rectangle; inferring the value of the identifier to be equal to a value of a previously signaled identifier plus a first value; and determining the constituent rectangle based on the inferring.

Example 77: The method of example 76, wherein when an index of the constituent rectangle is equal to zero, the value of the identifier is inferred to be equal to 0.

Example 78: The method of any of the examples 76 or 77, wherein the method is further caused to perform: receiving an associated constituent rectangle identifier within the constituent rectangle information message for associating a second constituent rectangle with the constituent rectangle.

Example 79: The method of example 78 further comprising: receiving an enable flag; receiving, when the enable flag is set to a second value, a presence flag for the constituent rectangle, wherein the associated constituent rectangle identifier is received when the presence flag is set to a third value.

Example 80: The method of any of the examples 76 to 79 further comprising: receiving a group identifier within the constituent rectangle information message, wherein the group identifier provides a capability to group two or more constituent rectangles sharing same value for the group identifier.

Example 81: The method of example 80, wherein each constituent rectangle of the two or more constituent rectangles comprises a unique value of the identifier.

Example 82: The method of any of the examples 76 to 81 further comprising: receiving a constituent rectangle nesting information message, wherein the constituent rectangle nesting information message provides a mechanism for associating a list of information messages with a set of constituent rectangles, wherein the constituent rectangle nesting information message comprises one or more information messages.

Example 83: The method of example 82, wherein the constituent rectangle nesting information message comprises syntax to indicate the set of constituent rectangles for which the list of constituent rectangle information messages applies.

Example 84: The method of any of the examples 82 or 83, wherein the constituent rectangle nesting information message is comprised in a current picture unit, when the constituent rectangle information message is comprised in the current picture unit or in a picture unit that precedes the current picture unit in decoding order within a current coded layer video sequence.

Example 85: The method of any of examples 82 or 83 further comprising: receiving following variables for interpretation of the constituent rectangle nesting information message: nested layers variables for identifying nested layers; and/or a syntax structure for receiving contents of the constituent rectangle nesting information message.

Example 86: The method of example 85, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 87: The method of any of the examples 85 or 86, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 88: The method of example 87, wherein the syntax structure comprises a constituent rectangle nesting information message byte field comprising a first index and a second index for specifying a byte corresponding to first index of a constituent rectangle nesting information message corresponding to the second index.

Example 89: A method comprising: receiving a constituent rectangle information message; and receiving an associated constituent rectangle identifier within the constituent rectangle information message, wherein the associated constituent rectangle identifier is used for associating a second constituent rectangle with the constituent rectangle.

Example 90: The method of example 89, wherein when a depth representation information message applies to a current picture, the associated constituent rectangle identifier indicates the primary constituent rectangle associated with a constituent rectangle of type depth.

Example 91: The method of example 89, wherein when an alpha channel information message applies to a current picture, the associated constituent rectangle identifier indicates the primary constituent rectangle associated with constituent rectangle of type alpha to provide information about alpha channel sample values and post-processing applied to the decoded alpha planes coded in a constituent rectangle of type alpha and the associated constituent rectangle.

Example 92: A method comprising: receiving a constituent rectangle information message; and receiving a group identifier within the constituent rectangle information message to provide a capability to group two or more constituent rectangles sharing same value for the group identifier.

Example 93: The method of example 92, wherein when a multiview acquisition information message is present, the group identifier indicates a view identifier or determines which constituent rectangles that the parameters signaled in the multiview acquisition information message apply to.

Example 94: A method comprising: receiving a constituent rectangle nesting information message, wherein constituent rectangle nesting information message provides a mechanism for associating a list of information messages with a set of constituent rectangles; and wherein the constituent rectangle nesting information message comprises one or more information messages.

Example 95: The method of example 94, wherein the constituent rectangle nesting information message comprises syntax to indicate the set of constituent rectangles for which the list of constituent rectangle information messages applies.

Example 96: The method of any of the examples 94 or 95, wherein the constituent rectangle nesting information message is comprised in a current picture unit, when the constituent rectangle information message is comprised in the current picture unit or in a picture unit that precedes the current picture unit in decoding order within a current coded layer video sequence.

Example 97: The method of any of examples 94 or 95, wherein following variables are specified for interpretation of the constituent rectangle nesting information message: nested layers variables for identifying nested layers; and/or a syntax structure for signaling contents of the constituent rectangle nesting information message.

Example 98: The method of example 97, wherein the nested layers variables are derived as following: when the constituent rectangle nesting information message is nested in a scalable nested information message, nested layers are determined by syntax elements of the scalable nesting information message; and when the constituent rectangle nesting information message is not the scalable-nested information message, the nested layers comprises a current layer.

Example 99: The method of any of the examples 97 or 98, wherein the syntax structure comprises one or more of the following: a first syntax element for specifying a number of constituent rectangles in each picture in the nested layers to which the constituent rectangle nesting information message applies; a second syntax element for specifying a number of bits used to represent the syntax structure; a third syntax element for specifying a constituent rectangle identifier for the constituent rectangle in each picture in the nested layers to which the constituent rectangle nesting information messages applies; and/or a fourth syntax element for specifying a number of constituent rectangle nesting information messages.

Example 100: The method of example 99, wherein the syntax structure comprises a constituent rectangle nesting information message byte field comprising a first index and a second index for specifying a byte corresponding to first index of a constituent rectangle nesting information message corresponding to the second index.

Example 101: An apparatus comprising means for performing methods as described in any of the examples 51 to 100.

Example 102: A computer readable medium comprising program instructions that, when executed by an apparatus, cause the apparatus to perform the methods as described in any of the examples 51 to 100.

Example 103: The computer readable medium example 102, wherein the computer readable medium comprises a non-transitory computer readable medium.

### BRIEF DESCRIPTION OF THE DRAWINGS

The foregoing embodiments and other features are explained in the following description, taken in connection with the accompanying drawings, wherein:

FIG. 1 shows schematically an apparatus employing embodiments of the examples described herein.

FIG. 2 shows schematically a user equipment suitable for employing embodiments of the examples described herein.

FIG. 3 further shows schematically electronic devices employing embodiments of the examples described herein connected using wireless and wired network connections.

FIG. 4 is a block diagram illustrating a system in accordance with an example.

FIG. 5 is an example apparatus, which may be implemented in hardware, and is caused to, implement examples described herein.

FIG. 6 shows a representation of an example of non-volatile memory media used to store instructions that implement the examples described herein.

FIG. 7 is an example method performed with an encoder, based on the examples described herein.

FIG. 8 is another example method performed with an encoder, based on the examples described herein.

FIG. 9 is yet another example method performed with an encoder, based on the examples described herein.

FIG. 10 is still another example method performed with an encoder, based on the examples described herein.

FIG. 11 is an example method performed with a decoder, based on the examples described herein.

FIG. 12 is another example method performed with a decoder, based on the examples described herein.

FIG. 13 is yet another example method performed with a decoder, based on the examples described herein.

FIG. 14 is still another example method performed with a decoder, based on the examples described herein.

### DETAILED DESCRIPTION OF EXAMPLE EMBODIMENTS

The following acronyms and abbreviations that may be found in the specification and/or the drawing figures are defined as follows (the abbreviations may be appended with each other or with other characters using e.g. a hyphen or dash (-), and may be case insensitive):
4CC four character code
5G fifth generation cellular network technology
5GC 5G core network
a.k.a. also known as
AVC advanced video coding
CU coding unit
DSP digital signal processor
DU distributed unit
eNB (or eNodeB) evolved Node B (for example, an LTE base station)
EN-DC E-UTRA-NR dual connectivity
en-gNB or En-gNB node providing NR user plane and control plane protocol terminations towards the UE, and acting as secondary node in EN-DC
E-UTRA evolved universal terrestrial radio access, for example, the LTE radio access technology
F1 or F1-C interface between CU and DU control interface
gNB (or gNodeB) base station for 5G/NR, for example, a node providing NR user plane and control plane protocol terminations towards the UE, and connected via the NG interface to the 5GC
IEC International Electrotechnical Commission
IoT internet of things
ISO International Organization for Standardization
ISOBMFF ISO base media file format
JPEG joint photographic experts group
LTE long-term evolution
mdat MediaDataBox
MIME Multipurpose Internet Mail Extension
MME mobility management entity
moov MovieBox
MP4 file format for MPEG-4 Part 14 files
MPEG moving picture experts group
MPEG-2 H.222/H.262 as defined by the ITU
MPEG-4 audio and video coding standard for ISO/IEC 14496
ng or NG new generation
ng-eNB or NG-eNB new generation eNB
NR new radio (5G radio)
N/W or NW network
PDCP packet data convergence protocol
PHY physical layer
PNG portable network graphics
RAN radio access network
RFC request for comments
RLC radio link control
RRC radio resource control
RRH remote radio head
RU radio unit
Rx receiver
SDAP service data adaptation protocol
SGW serving gateway
SMF session management function
SPS sequence parameter set
SVC scalable video coding
S1 interface between eNodeBs and the EPC
trak TrackBox
Tx transmitter
UE user equipment
UICC Universal Integrated Circuit Card
UPF user plane function
URL uniform resource locator
X2 interconnecting interface between two eNodeBs in LTE network
Xn interface between two NG-RAN nodes

Some embodiments will now be described more fully hereinafter with reference to the accompanying drawings, in which some, but not all, embodiments may be shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms ‘data,’ ‘content,’ ‘information,’ and similar terms may be used interchangeably to refer to data capable of being transmitted, received and/or stored in accordance with embodiments of the present invention. Thus, use of any such terms should not be taken to limit the spirit and scope of embodiments.

Described herein is a method and apparatus for usages of constituent rectangles in coded video.

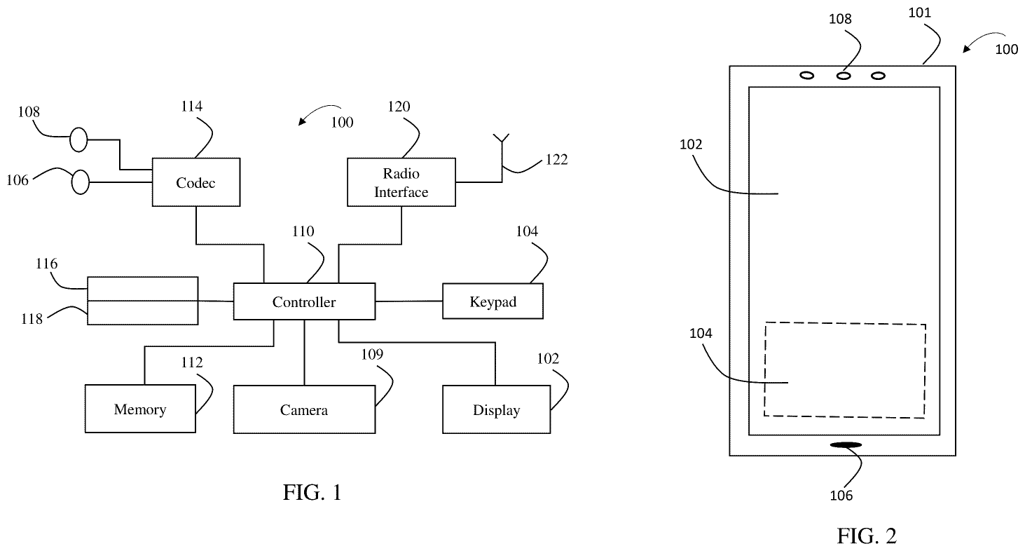

The following describes in detail a suitable apparatus and possible method for usages of constituent rectangles in coded video according to various embodiments. In this regard reference is first made to FIG. 1 and FIG. 2, where FIG. 1 shows an example block diagram of an electronic device or apparatus 100. The apparatus 100 may be an Internet of Things (IoT) apparatus configured to perform various functions, such as for example, gathering information by one or more sensors, receiving or transmitting information, analyzing information gathered or received by the apparatus, or the like. The apparatus may comprise a video coding system, which may incorporate a codec. FIG. 2 shows a layout of an apparatus according to an example embodiment. The elements of FIG. 1 and FIG. 2 are explained next.

The apparatus 100 may for example be a mobile terminal or user equipment of a wireless communication system, a sensor device, a tag, or other lower power device. However, it would be appreciated that embodiments of the examples described herein may be implemented within any electronic device or apparatus which may process data by neural networks.

The apparatus 100 may comprise a housing 101 for incorporating and protecting the device. The apparatus 100 further may comprise a display 102 in the form of a liquid crystal display. In other embodiments of the examples described herein the display may be any suitable display technology suitable to display an image or video. The apparatus 100 may further comprise a keypad 104. In other embodiments of the examples described herein any suitable data or user interface mechanism may be employed. For example the user interface may be implemented as a virtual keyboard or data entry system as part of a touch-sensitive display.

The apparatus may comprise a microphone 106 or any suitable audio input which may be a digital or analog signal input. The apparatus 100 may further comprise an audio output device which in embodiments of the examples described herein may be any one of: an earpiece 108, speaker, or an analog audio or digital audio output connection. The apparatus 100 may also comprise a battery (or in other embodiments of the examples described herein the device may be powered by any suitable mobile energy device such as solar cell, fuel cell or clockwork generator). The apparatus 100 may further comprise a camera 109 capable of recording or capturing images and/or video. The apparatus 100 may further comprise an infrared port for short range line of sight communication to other devices. In other embodiments the apparatus 100 may further comprise any suitable short range communication solution such as for example a Bluetooth wireless connection or a USB/firewire wired connection.

The apparatus 100 may comprise a controller 110, processor or processor circuitry for controlling the apparatus 100. The controller 110 may be connected to memory 112 which in embodiments of the examples described herein may store both data in the form of image and audio data and/or may also store instructions for implementation on the controller 110. The controller 110 may further be connected to codec circuitry 114 suitable for carrying out coding and/or decoding of audio and/or video data or assisting in coding and/or decoding carried out by the controller.

The apparatus 100 may further comprise a card reader 118 and a smart card 116, for example a UICC and UICC reader for providing user information and being suitable for providing authentication information for authentication and authorization of the user at a network.

The apparatus 100 may comprise radio interface circuitry 120 connected to the controller and suitable for generating wireless communication signals for example for communication with a cellular communications network, a wireless communications system or a wireless local area network. The apparatus 100 may further comprise an antenna 122 connected to the radio interface circuitry 120 for transmitting radio frequency signals generated at the radio interface circuitry 120 to other apparatus(es) and/or for receiving radio frequency signals from other apparatus(es).

The apparatus 100 may comprise a camera capable of recording or detecting individual frames which are then passed to the codec circuitry 114 or the controller for processing. The apparatus may receive the video image data for processing from another device prior to transmission and/or storage. The apparatus 100 may also receive either wirelessly or by a wired connection the image for coding/decoding. The structural elements of apparatus 100 described above represent examples of means for performing a corresponding function.

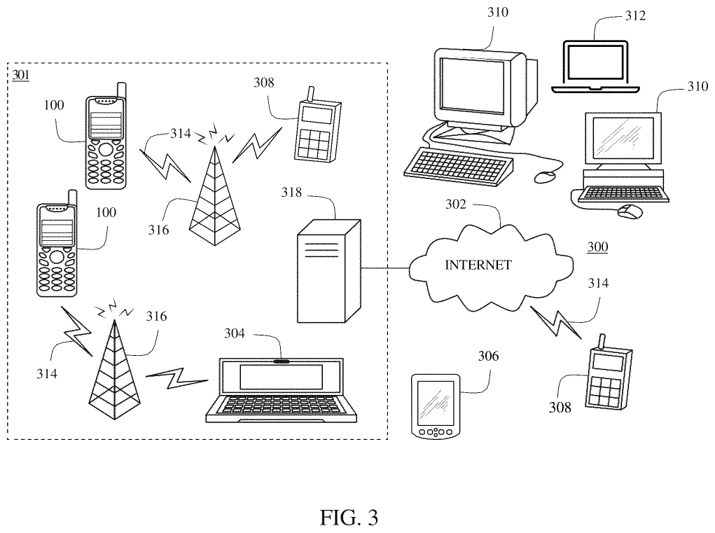

With respect to FIG. 3, an example of a system within which embodiments of the examples described herein can be utilized is shown. The system 300 comprises multiple communication devices which can communicate through one or more networks. The system 300 may comprise any combination of wired or wireless networks including, but not limited to a wireless cellular telephone network (such as a GSM, UMTS, CDMA, LTE, 4G, 5G network, etc.), a wireless local area network (WLAN) such as defined by any of the IEEE 802.x standards, a Bluetooth personal area network, an Ethernet local area network, a token ring local area network, a wide area network, and the Internet.

The system 300 may include both wired and wireless communication devices and/or apparatus 100 suitable for implementing embodiments of the examples described herein.

For example, the system shown in FIG. 3 shows a mobile telephone network 301 and a representation of the internet 302. Connectivity to the internet 302 may include, but is not limited to, long range wireless connections, short range wireless connections, and various wired connections including, but not limited to, telephone lines, cable lines, power lines, and similar communication pathways.

The example communication devices shown in the system 300 may include, but are not limited to, an electronic device or apparatus 100, a combination of a personal digital assistant (PDA) and a mobile telephone 304, a PDA 306, an integrated messaging device (IMD) 308, a desktop computer 310, a notebook computer 312, or a head-mounted apparatus. The head-mounted apparatus may be a head-mounted display (HMD), or glasses having a device such as a camera configured to encode and/or decode images and/or video. The apparatus 100 may be stationary or mobile when carried by an individual who is moving. The apparatus 100 may also be located in a mode of transport including, but not limited to, a car, a truck, a taxi, a bus, a train, a boat, an airplane, a bicycle, a motorcycle or any similar suitable mode of transport.

The embodiments may also be implemented in a set-top box; e.g., a digital TV receiver, which may/may not have a display or wireless capabilities, in tablets or (laptop) personal computers (PC), which have hardware and/or software to process neural network data, in various operating systems, and in chipsets, processors, DSPs and/or embedded systems offering hardware/software based coding.

Some or further apparatus may send and receive calls and messages and communicate with service providers through a wireless connection 314 to a base station 316. The base station 316 may be connected to a network server 318 that allows communication between the mobile telephone network 301 and the internet 302. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11, 3GPP Narrowband IoT and any similar wireless communication technology. A communications device involved in implementing various embodiments of the examples described herein may communicate using various media including, but not limited to, radio, infrared, laser, cable connections, and any suitable connection.

In telecommunications and data networks, a channel may refer either to a physical channel or to a logical channel. A physical channel may refer to a physical transmission medium such as a wire, whereas a logical channel may refer to a logical connection over a multiplexed medium, capable of conveying several logical channels. A channel may be used for conveying an information signal, for example a bitstream, from one or several senders (or transmitters) to one or several receivers.

The embodiments may also be implemented in so-called IoT devices. The Internet of Things (IoT) may be defined, for example, as an interconnection of uniquely identifiable embedded computing devices within the existing Internet infrastructure. The convergence of various technologies has and may enable many fields of embedded systems, such as wireless sensor networks, control systems, home/building automation, etc. to be included in the Internet of Things (IoT). In order to utilize the Internet IoT devices are provided with an IP address as a unique identifier. IoT devices may be provided with a radio transmitter, such as a WLAN or Bluetooth transmitter or a RFID tag. Alternatively, IoT devices may have access to an IP-based network via a wired network, such as an Ethernet-based network or a power-line connection (PLC).

Version 1 of the High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (VVC) (MPEG-I Part 3), a.k.a. ITU-T H.266, is a video compression standard developed by the Joint Video Experts Team (JVET) of the Moving Picture Experts Group (MPEG), (formally ISO/IEC JTC1 SC29 WG11) and Video Coding Experts Group (VCEG) of the International Telecommunication Union (ITU) to be the successor to HEVC/H.265.

A specification of the AV1 bitstream format and decoding process were developed by the Alliance for Open Media (AOM). The AV1 specification was published in 2018. AOM is reportedly working on the AV2 specification.

Some key definitions, bitstream and coding structures, and concepts of some video coding standards and specifications are described in this section for providing background for a video encoder, decoder, encoding method, decoding method, and a bitstream structure, wherein the embodiments may be implemented. It is to be understood that embodiments are not limited to the referenced video coding standards or specifications.

A bitstream may be defined as a sequence of bits or a sequence of syntax structures. A bitstream format may constrain the order of syntax structures in the bitstream.

A syntax element may be defined as an element of data represented in a bitstream. A syntax structure may be defined as zero or more syntax elements present together in a bitstream in a specified order.

Syntax structures may be specified, for example, using arithmetic, logical, relational, bit-wise, and assignment operators similar to those available in many programming languages. For example, & may indicate a bit-wise ‘AND’ operation. Furthermore, syntax structures may be specified with reference to mathematical functions.

Syntax structures and semantics may use the values of variables derived from the values of syntax elements. Naming conventions may be defined for variables. For example, variables may be named by a mixture of lower case and upper case letter and without any underscore characters. Variables starting with an upper case letter may be derived for the decoding of the current syntax structure and all depending syntax structures. Variables starting with an upper case letter may, in some cases, be used in the decoding process for later syntax structures without mentioning the originating syntax structure of the variable. Variables starting with a lower case letter may only be used in relation to the syntax structure or function they have been defined for.

An elementary unit for the output of an encoder and the input of a decoder, respectively, may be a Network Abstraction Layer (NAL) unit. For transport over packet-oriented networks or storage into structured files, NAL units may be encapsulated into packets or similar structures. A bytestream format has been specified in some video coding standards for transmission or storage environments that do not provide framing structures. The bytestream format separates NAL units from each other by attaching a start code in front of each NAL unit. To avoid false detection of NAL unit boundaries, encoders run a byte-oriented start code emulation prevention algorithm, which adds an emulation prevention byte to the NAL unit payload if a start code would have occurred otherwise. In order to enable straightforward gateway operation between packet- and stream-oriented systems, start code emulation prevention may always be performed regardless of whether the bytestream format is in use or not. A NAL unit may be defined as a syntax structure containing an indication of the type of data to follow and bytes containing that data in the form of an RBSP interspersed as necessary with emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A bitstream may be defined to logically include a syntax structure, such as a NAL unit, when the syntax structure is transmitted along the bitstream but may be included in the bitstream according to the bitstream format. A bitstream may be defined to natively comprise a syntax structure, when the bitstream includes the syntax structure.

In some coding formats or standards, a bitstream may be in the form of a network abstraction layer (NAL) unit stream or a byte stream, that forms the representation of coded pictures and associated data forming one or more coded video sequences.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

In some coding standards, NAL units include a header and payload. In some coding standards, the NAL unit header indicates the type of the NAL unit. In some coding standards, the NAL unit header indicates a scalability layer identifier (e.g., called nuh_layer_id), which may be used, e.g., for indicating spatial or quality layers, views of a multiview video, or auxiliary layers (such as depth maps or alpha planes). In some coding standards, the NAL unit header includes a temporal sublayer identifier, which may be used for indicating temporal subsets of the bitstream, such as a 30-frames-per-second subset of a 60-frames-per-second bitstream.

NAL units can be categorized into Video Coding Layer (VCL) NAL units and non-VCL NAL units. VCL NAL units are typically coded slice NAL units.

A non-VCL NAL unit may be for example one of the following types: a video parameter set (VPS), a sequence parameter set (SPS), a picture parameter set (PPS), a supplemental enhancement information (SEI) NAL unit, an access unit delimiter, an end of sequence (EOS) NAL unit, an end of bitstream (EOB) NAL unit, or a filler data NAL unit. Parameter sets may be needed for the reconstruction of decoded pictures, whereas many of the other non-VCL NAL units may not be necessary for the reconstruction of decoded sample values.

In some video coding formats, such as VVC, a subpicture may be defined as a rectangular region of one or more slices within a picture, wherein the one or more slices are complete. An independent VVC subpicture is treated like a picture in the VVC decoding process. When the motion compensation would reference a sample location outside of boundaries of an independent VVC subpicture, the sample location is saturated to be within the subpicture. Moreover, it may additionally be required that loop filtering across the boundaries of an independent VVC subpicture is disabled. Boundaries of a subpicture are treated like picture boundaries in the VVC decoding process when sps_subpic_treated_as_pic_flag[i] is equal to 1 for the subpicture. Loop filtering across the boundaries of a subpicture is disabled in the VVC decoding process when sps_loop_filter_across_subpic_enabled_pic_flag[i] is equal to 0.

A coded picture may be defined as a coded representation of a picture.

In some coding formats, picture unit (PU) may be defined as a set of data units, such as NAL units, that are associated with each other, are consecutive in decoding order, and contain exactly one coded picture. For example, certain non-video-coding data units, such as non-VCL NAL units, may be next to coded video data units in decoding order and the respective picture unit may comprise both these non-video-coding data units and the video coding data units of a coded picture.

In some coding formats, an access unit (AU) may be defined as a set of NAL units that are associated with each other according to a specified classification rule, are consecutive in decoding order, and include at most one coded picture at any scalability layer (e.g., with any specific value of nuh_layer_id in some coding formats, such as HEVC or VVC). In some coding formats, an access unit comprises one or more complete picture units. In some coding formats, in addition to including the VCL NAL units of a coded picture, an access unit may also include non-VCL NAL units associated with the coded picture. Said specified classification rule may, for example, associate pictures with the same output time or picture order count value into the same access unit.

In some coding formats, a coded video sequence (CVS) may be defined as a sequence of coded pictures in decoding order that is independently decodable and is followed by another coded video sequence or the end of the bitstream.

In some coding formats, such as AV1, a coded video sequence comprises one or more temporal units. A temporal unit consists of a series of OBUs starting from a temporal delimiter, optional sequence headers, optional metadata OBUs, a sequence of one or more frame headers, each followed by zero or more tile group OBUs as well as optional padding OBUs. A temporal unit may be defined to comprise all the OBUs that are associated with a specific, distinct time instant. A temporal unit may comprise a temporal delimiter OBU, and all the OBUs that follow, up to but not including the next temporal delimiter. A temporal delimiter OBU may be defined as an indication that the following OBUs will have a different presentation/decoding time stamp from the one of the last frame prior to the temporal delimiter.

A coded layer video sequence (CLVS) may be defined as a sequence of pictures and associated other data within the same scalable layer (e.g., with the same value of nuh_layer_id) that is decodable independently of other pictures in the same layer.

Video coding specifications may enable the use of supplemental enhancement information (SEI) messages or alike. Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages, which may not be required for the decoding of output pictures but may assist in related processes, such as picture output timing, post-processing of decoded pictures, rendering, error detection, error concealment, and resource reservation.

Some video coding specifications enable metadata OBUs. A metadata OBU comprises a type field, which specifies the type of metadata. A metadata OBU may be understood to be similar to an SEI NAL unit or an SEI message.

ITU-T Recommendation H.274, which is equivalent to ISO/IEC 23002-7, may be called “versatile supplemental enhancement information messages for coded video bitstreams” and be referred to as “versatile supplemental enhancement information” or VSEI. The VSEI standard specifies the syntax and semantics of video usability information (VUI) parameters and supplemental enhancement information (SEI) messages. The VUI parameters and SEI messages defined in the VSEI standard are designed to be conveyed within coded video bitstreams in a manner specified in a video coding specification or to be conveyed by other means determined by the specifications for systems that make use of such coded video bitstreams. The VSEI standard is intended for use with VVC coded video bitstreams, although it is drafted in a manner intended to be sufficiently generic that it may also be used with other types of coded video bitstreams.

ITU-T Recommendation T.35 specifies a mechanism to register metadata structures that are identified by a country code, a terminal provider code, and a terminal provider oriented code. ITU-T T.35 metadata starts with the country code, which is followed by the payload registered as specified in ITU-T Recommendation T.35. The ITU-T T.35 terminal provider code and terminal provider oriented code shall be contained in the first one or more bytes of the payload, in the format specified by the Administration that issued the terminal provider code. Any remaining payload data shall be data having syntax and semantics as specified by the entity identified by the ITU-T T.35 country code and terminal provider code. ITU-T T.35 metadata may be carried, for example, in an SEI message or metadata OBU.

Scalable video coding may refer to coding structure where one bitstream may include multiple representations of the content, for example, at different bitrates, resolutions or frame rates. In these cases the receiver can extract the desired representation depending on its characteristics (e.g., resolution that matches best the display device). Alternatively, a server or a network element may extract the portions of the bitstream to be transmitted to the receiver depending on, e.g., the network characteristics or processing capabilities of the receiver. A meaningful decoded representation may be produced by decoding only certain parts of a scalable bitstream. A scalable bitstream typically include of a ‘base layer’ providing the lowest quality video available and one or more enhancement layers that enhance the video quality when received and decoded together with the lower layers. In order to improve coding efficiency for the enhancement layers, the coded representation of that layer typically depends on the lower layers. For example, the motion and mode information of the enhancement layer can be predicted from lower layers. Similarly, the pixel data of the lower layers can be used to create prediction for the enhancement layer.

A scalable bitstream may include a ‘base layer’ providing the lowest quality video available and one or more enhancement layers that enhance the video quality when received and decoded together with the lower layers. In order to improve coding efficiency for the enhancement layers, the coded representation of that layer may depend on the lower layers. E.g., the motion and mode information of the enhancement layer may be predicted from lower layers. Similarly, the pixel data of the lower layers can be used to create prediction for the enhancement layer.

A scalable video codec for quality scalability (also known as signal-to-noise or SNR) and/or spatial scalability may be implemented as follows. For a base layer, a conventional non-scalable video encoder and decoder is used. The reconstructed/decoded pictures of the base layer are included in the reference picture buffer for an enhancement layer. In codecs using reference picture list(s) for inter prediction, the base layer decoded pictures may be inserted into a reference picture list(s) for coding/decoding of an enhancement layer picture similarly to the decoded reference pictures of the enhancement layer. Consequently, the encoder may choose a base-layer reference picture as inter prediction reference and indicate its use, e.g., with a reference picture index in the coded bitstream. The decoder decodes from the bitstream, for example from a reference picture index, that a base-layer picture is used as inter prediction reference for the enhancement layer. When a decoded base-layer picture is used as prediction reference for an enhancement layer, it is referred to as an inter-layer reference picture.

It needs to be understood that the description of scalable video coding may be generalized to any scalability hierarchy with more than two layers. In this case, a second enhancement layer may depend on a first enhancement layer in encoding and/or decoding processes, and the first enhancement layer may therefore be regarded as the base layer for the encoding and/or decoding of the second enhancement layer. Furthermore, it needs to be understood that there may be inter-layer reference pictures from more than one layer in a reference picture buffer or reference picture lists of an enhancement layer, and each of these inter-layer reference pictures may be considered to reside in a base layer or a reference layer for the enhancement layer being encoded and/or decoded. Furthermore, it needs to be understood that other types of inter-layer processing than reference-layer picture upsampling may take place instead or additionally. For example, the bit-depth of the samples of the reference-layer picture may be converted to the bit-depth of the enhancement layer and/or the sample values may undergo a mapping from the color space of the reference layer to the color space of the enhancement layer.

A scalable video coding and/or decoding scheme may use multi-loop coding and/or decoding, which may be characterized as follows. In the encoding/decoding, a base layer picture may be reconstructed/decoded to be used as a motion-compensation reference picture for subsequent pictures, in coding/decoding order, within the same layer or as a reference for inter-layer (or inter-view or inter-component) prediction. The reconstructed/decoded base layer picture may be stored in the decoded picture buffer (DPB). An enhancement layer picture may likewise be reconstructed/decoded to be used as a motion-compensation reference picture for subsequent pictures, in coding/decoding order, within the same layer or as reference for inter-layer (or inter-view or inter-component) prediction for higher enhancement layers, when any. In addition to reconstructed/decoded sample values, syntax element values of the base/reference layer or variables derived from the syntax element values of the base/reference layer may be used in the inter-layer/inter-component/inter-view prediction.

Inter-layer prediction may be defined as prediction in a manner that is dependent on data elements (e.g., sample values or motion vectors) of reference pictures from a different layer than the layer of the current picture (being encoded or decoded). Many types of inter-layer prediction exist and may be applied in a scalable video encoder/decoder.

A multi-layer bitstream is a bitstream comprising multiple layers, which may be, but are not limited to, base and enhancement layers as discussed above for scalable video coding. A multi-layer bitstream may additionally or alternatively comprise independent layers that do not have inter-layer prediction relationship between each other and may even represent different types of content. Any multi-layer bitstream may be regarded as a scalable video bitstream.

Constituent rectangles (CRs) may be defined as rectangular regions within a coded picture, for which their size and position is signaled. Constituent rectangles and their properties may be indicated in the constituent rectangles SEI message. A constituent rectangle type may be signaled, such as texture, alpha, or depth. In an example, the texture may include a regular video. Additionally or alternatively, the texture may be referred to as color. A constituent rectangle type identifier may be signaled, or its value may be inferred the index order.

The constituent rectangles SEI messages may use subpicture parameters to identify the size and position of CRs to save bitrate, but use of subpictures is not required. Subpictures have normative encoder/decoder behaviors, while the constituent rectangles SEI, like other SEI messages, does not have any normative impact, but can be used for post-processing.

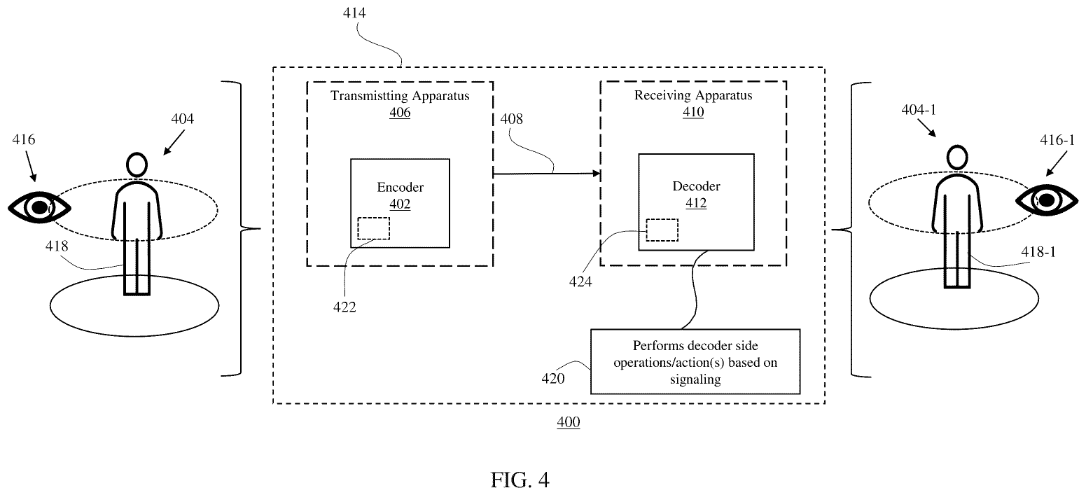

FIG. 4 is a block diagram illustrating a system or apparatus 400 in accordance with several examples. In an example, the encoder 402 is used to encode an image or video from the scene 404, and the encoder 402 is implemented in a transmitting apparatus 406. The encoder 402 produces a bitstream 408 comprising signaling that is received by the receiving apparatus 410, which implements a decoder 412. The encoder 402 sends the bitstream 408 that comprises the herein described signaling. The decoder 412 forms the image or video for the scene 404-1, and the receiving apparatus 410 would present this to the user, e.g., via a smartphone, television, or projector among many other options.

In some examples, the transmitting apparatus 406 and the receiving apparatus 410 are at least partially within a common apparatus, and for example, are located within a common housing 414. In other examples the transmitting apparatus 406 and the receiving apparatus 410 are at least partially not within a common apparatus and have at least partially different housings. Therefore in some examples, the encoder 402 and the decoder 412 are at least partially within a common apparatus, and for example are located within a common housing 414. For example, the common apparatus comprising the encoder 402 and decoder 412 implements a codec. In other examples, the encoder 402 and the decoder 412 are at least partially not within a common apparatus and have at least partially different housings, but when together still implement a codec.

In some examples, 3D media from the capture (e.g., volumetric capture) at a viewpoint 416 of the scene 404, which includes a person 418) is converted via projection to a series of 2D representations with occupancy, geometry, attributes and/or displacements. Additional atlas information is also included in the bitstream to enable inverse reconstruction. For decoding, the received bitstream 408 is separated into its components with atlas information; occupancy, geometry, displacement, and attribute 2D representations. A 3D reconstruction is performed to reconstruct the scene 404-1 created looking at the viewpoint 416-1 with a “reconstructed” person 418-1. The “-1” are used to indicate that these are reconstructions of the original. As indicated at 420, the decoder 412 performs an operation(s) or action(s) based on the received signaling.

Encoding 422 performs encoding of constituent rectangles based on the examples described herein. Decoding 424 performs decoding of constituent rectangles, based on the examples described herein.

Having thus introduced a suitable but non-limiting technical context for the practice of the example embodiments of the present disclosure, example embodiments will now be described in detail.

### Constituent Rectangle (CR) Supplemental Enhancement Information (SEI) Message and Constituent Region Nesting SEI Message

The constituent region nesting SEI message indicates one or more constituent regions, e.g., through their IDs, and includes one or more nested SEI messages. The nested SEI messages apply to the indicated constituent regions. For example, the constituent region nesting SEI message may include multiview acquisition, multiview view position, depth representation, and/or alpha channel information SEI message, among others.

Constituent rectangles, apply to the current layer that the CR SEI is present in.

A scalable nesting SEI message includes one or more SEI messages. The SEI messages included in the scalable nesting SEI message are also referred to as the scalable-nested SEI messages. A scalable nesting SEI message comprises information indicative of which subset of the bitstream the scalable-nested SEI messages apply.

Versatile video coding (VVC) includes a scalable nesting (SN) SEI message. The scalable nesting SEI message provides a mechanism to associate SEI messages with specific output layer sets (OLSs), specific layers, or specific sets of subpictures.

Versatile supplemental enhancement information (VSEI) defines the scalability dimension information (SDI) SEI message, the multiview acquisition information (MAI) SEI message, depth representation information (DRI) SEI message, and the alpha channel information (ACI) SEI message.

The scalability dimension information (SDI) SEI message provides the SDI for each layer in the current coded video sequence (CVS), e.g., the coded video sequence (CVS) including the SDI SEI message, such as: 1) when there may be multiple views, the view identifier (ID) of each layer; and 2) when there may be auxiliary information (such as depth or alpha) carried by one or more layers, the auxiliary ID of each layer.

The multiview acquisition information (MAI) SEI message specifies various parameters of the acquisition environment for the layers that may be present in the current CVS, e.g., the CVS including the MAI SEI message. Specifically, intrinsic and extrinsic camera parameters are specified. These parameters could be used for processing the decoded views prior to rendering on a 3D display.

The syntax elements in the depth representation information (DRI) SEI message specify various parameters for auxiliary pictures of type AUX_DEPTH for the purpose of processing decoded primary and auxiliary pictures prior to rendering on a 3D display, such as view synthesis. Specifically, depth or disparity ranges for depth pictures are specified.

The alpha channel information (ACI) SEI message provides information about alpha channel sample values and post-processing applied to the decoded alpha planes coded in auxiliary pictures of type AUX_ALPHA and one or more associated primary pictures.

High efficiency video coding (HEVC) includes a regional nesting SEI message. The regional nesting SEI message provides a mechanism to associate SEI messages with regions of the picture. The associated SEI messages are conveyed within the regional nesting SEI message.

A regional nesting SEI message includes one or more SEI messages. When an SEI message is included in a regional nesting SEI message, the included SEI message is referred to as a region-nested SEI message. When an SEI message is not included in a regional nesting SEI message, the SEI message is referred to as a non-region-nested SEI message.

For each region-nested SEI message in a regional nesting SEI message, one or more regions are specified in the regional nesting SEI message, and the semantics of the region-nested SEI message are to be interpreted as applying to each of these regions.

A constituent region nesting SEI message can be used to associated SEI message with one or more constituent rectangles.

When subpictures are included in the VVC scalable nesting (SN) SEI message, subpictures in layers identified in the SN SEI message are associated with the specified nested SEI messages.

The semantics of the MAI, ACI, and DRI SEI messages specify that the SEI messages apply to auxiliary pictures and do not allow use with picture regions or constituent rectangles, and do not allow association with picture regions or constituent rectangles.

The MAI, ACI, and DRI SEI message semantics include a restriction that the SDI SEI message be present in the same CVS as those SEI messages. In the SDI SEI message, an sdi_aux_id[i] syntax element can be used to indicate that an auxiliary picture layer is of type AUX_ALPHA or AUX_DEPTH. The SDI SEI message requires that an associated primary layer be signaled for each auxiliary picture layer.

Constituent rectangle SEI message is described in a JVET contribution JVET-AH0162 available from [https://jvet-experts.org/doc_end_user/documents/34_Rennes/wg11/JVET-AH0162-v1.zip (last accessed on Jul. 3, 2024)], which is hereby incorporated herein by reference in its entirety.

JVET-AH0162 describes how to infer the value of the i-th constituent rectangle ID, cr_rect_id[i], when it is not present, in its semantics:

cr_rect_id[i] indicates the ID of the i-th rectangle. The length of the syntax element is cr_rect_id_len bits. When not present, the value of cr_rect_id[i] is inferred to be equal to i.

It is useful to able to associate SEI messages with more than one constituent rectangle in one or more layers in a multi-layer bitstream.

It is useful to be able to use MAI, ACI, and DRI SEI messages to apply to constituent rectangles without applying to the entire picture including the constituent rectangles. For some usages, the constituent rectangles may have different types, and it would be inappropriate to apply a particular SEI message to that constituent rectangle.

It also is more bitrate efficient to have an SEI message apply to multiple constituent rectangles, to avoid the need to repeat the SEI message.

When a constituent rectangle is of type CR_ALPHA or CR_DEPTH or other types such as object mask which are normally associated with a primary picture, it is useful to be able to identify an associated constituent rectangle.

It is more bitrate efficient to avoid explicit signaling of the cr_rect_id[i] syntax element and infer its value, especially when many constituent rectangles are present.

Proposed embodiments modify the inference value of the i-th rectangle identifier, cr_rect_id[i], when it is not present in the CR SEI message, to be equal to the previous signalled value cr_rect_id[i−1] plus 1. This proposed modification allows gaps in the numbering of the identifier values, for example, to have meaningful bit fields in the identifier values, without requiring signaling of the cr_rect_id[i] syntax element for all constituent rectangles.

The proposed embodiments enable the CR SEI to optionally signal for individual constituent rectangles an associated constituent rectangle identifier. The embodiments add an associated rectangle identifier, cr_associated_rect_id[i], syntax element to the CR SEI, conditioned upon a presence flag, so that the i-th constituent rectangle of a CR_ALPHA or CR_DEPTH type may be associated with a primary constituent rectangle.

The proposed embodiments define syntax and semantics for a constituent rectangle nesting (CRN) SEI message. The CRN SEI message may be either nested within a scalable nesting SEI message, in which case the SEI messages it includes apply to the layers identified in the scalable nesting SEI message, or not nested within a scalable nesting SEI message, in which case the layers it includes apply to the current layer that includes the constituent rectangle nesting SEI message.

The existing scalable nesting SEI message in VVC does not provide the capability to associate specified subpictures for the current layer, but only for the layers identified in the scalable nesting SEI message.

The proposed embodiments modify the semantics of the MAI, ACI, and DRI SEI messages to enable their use with constituent rectangles, including allowing their use without the presence of an SDI message in the CVS. In an embodiment of the invention, either an SDI SEI message or a CR SEI message are required to be present in the MAI, ACI, and DRI SEI messages.

The semantics of the ACI and DRI SEI messages are modified to use the associated constituent rectangle identifier signaled in the CR SEI in a similar manner to how an alpha channel picture or depth picture are associated with a primary picture.

The MAI semantics are modified such that the camera parameters signaled for index i correspond to a particular constituent rectangle in a particular layer, when the CVS includes multiple layers.

Modify the inference of the cr_rect_id[i] syntax element in the CR SEI

It is proposed to modify the inference of the value of cr_rect_id[i] syntax element when not present, to be equal to the previous signalled value cr_rect_id[i−1] plus 1 rather than inferring its value to be i, as it is in the current design.

This proposed modification allows gaps in in the numbering of the ID values, for example, to have meaningful bit fields in the ID values, without requiring signaling of the cr_rect_id[i] syntax element for all CRs.

The proposed semantics of the cr_rect_id[i] are shown below:

cr_rect_id[i] indicates the ID of the i-th rectangle. The length of the syntax element is cr_rect_id_len bits. When not present and i equal to 0, the value of cr_rect_id[i] is inferred to be equal to i0. When not present and i greater than 0, the value of cr_rect_id[i] is inferred to be equal to cr_rect_id[i−1]+1.

It is a requirement of bitstream conformance that when j not equal to k, cr_rect_id[j] shall not be equal to cr_rect_id[k].

Add cr_associated_rect_id[i] and cr_rect_group_id[i] syntax elements to the CR SEI

It is proposed to add a cr_associated_rect_id[i] syntax element to the CR SEI, so that a constituent rectangle of a CR_ALPHA or CR_DEPTH type may be associated with a primary constituent rectangle, similar to how auxiliary picture layers may be associated with a primary picture layer in the scalability dimension information (SDI) SEI.

An enable flag, cr_associated_rect_id_enabled_flag, is signalled, and when it is equal to 1, a presence flag, cr_associated_rect_id_present_flag[i] is signalled for each constituent rectangle. When for the i-th constituent rectangle, the presence flag is equal to 1, an associated rectangle identifier, cr_associated_rect_id[i], syntax element is signalled. It is required that the signaled associated rectangle identifier be a valid identifier value that is also signaled the CR SEI message.

It is also proposed to add a cr_rect_group_id[i] syntax element to the CR SEI, to provide the capability to optionally group constituent rectangles together that share the same rect group ID value.

Each constituent rectangle in the CR SEI message must have a unique value of cr_rect_id[i], but multiple constituent rectangles may have the same value of cr_rect_group_id[i].

The rect group ID value could be used, for example to identify the view ID of a constituent rectangle in a picture with multiple views within a single layer or multi-layer bitstream.

Additional use cases for grouping of constituent rectangles can also be supported.

Following is an example syntax of the constituent rectangles:

| | Descriptor |
|---|---|
| constituent_rectangles( payloadSize ) { | |
| cr_num_rects_minus1 | u(12) |
| cr_rect_id_present_flag | u(1) |
| cr_associated_rect_id_enabled_flag | u(1) |
| cr_rect_group_id_present_flag | u(1) |
| if ( cr_rect_id_present_flag \| \| cr_associated_rect_id_enabled_flag \| \| | |
| cr_rect_group_id_present_flag \| ) | |
| cr_rect_id_len | u(4) |
| cr_rect_type_enabled_flag | u(1) |
| cr_rect_type_descriptions_enabled_flag | u(1) |
| cr_subpics_partitioning_flag | u(1) |
| if( !cr_subpics_partitioning_flag ) { | u(1) |
| cr_rect_same_size_flag | u(1) |
| if ( cr_rect_same_size_flag ) { | |
| cr_num_cols_minus1 | ue(v) |
| cr_num_rows_minus1 | ue(v) |
| } else { | |
| cr_log2_unit_size | u(4) |
| cr_rect_size_len_minus1 | u(4) |
| } | |
| } | |
| for( i = 0; i <= cr_num_rects_minus1; i++ ) { | |
| if ( cr_rect type_enabled_flag ) { | |
| cr_rect_type_present_flag[ i ] | u(1) |
| if ( cr_rect_type_present_flag[ i ] ) | |
| cr_rect_type_idc[ i ] | u(8) |
| } | |
| if ( cr_rect type_idc[ i ] != 255 ) { | |
| if ( cr_rect id_present_flag ) | |
| cr_rect_id[ i ] | u(v) |
| if ( cr_associated_rect id_enabled_flag ) { | |
| cr_associated_rect_id_present_flag[ i ] | u(1) |
| if ( cr_associated_rect_id_present_flag[ i ] ) | |
| cr_associated_rect_id[ i ] | u(v) |
| } | |
| if ( cr_group_id_present_flag ) { | |
| cr_rect_group_id[ i ] | u(v) |
| if ( cr_rect type_description_enabled_flag ) | |
| cr_rect_type_description_present_flag[ i ] | u(1) |
| } | |
| if( !cr_subpics_partitioning_flag && !cr_rects_same_size_flag ) { | |
| cr_rect_top_left_in_units_x[ i ] | u(v) |
| cr_rect_top_left_in_units_y[ i ] | u(v) |
| cr_rect_width_in_units_minus1[ i ] | u(v) |
| cr_rect_height_in_units minus1[ i ] | u(v) |
| } | |
| } | |
| if( cr_rect_type_descriptions_enabled_flag ) { | |
| while( !byte_aligned( ) ) | |
| cr_bit_equal_to_zero /* equal to 0 */ | f(1) |
| for( i = 0; i <= cr_num_rects_minus1; i++ ) | |
| if( rect_type_description_present_flag[ i ] ) | |
| cr_rect_type_description[ i ] | st(v) |
| } | |
| } | |

The semantics of the new syntax elements are provided below.

cr_associated_rect_id_enabled_flag equal to 1 specifies that the cr_associated_rect_id_present_flag[i] syntax elements are present. cr_associated_rect_id_enabled_flag equal to 0 specifies that the cr_associated_rect_id_present_flag[i] syntax elements are not present.

cr_rect_group_id_present_flag equal to 1 specifies that cr_rect_group_id[i] syntax elements are present. cr_rect_group_present_flag equal to 0 specifies that_cr_rect_group_id[i] syntax elements are not present.

cr_rect_id_len specifies the length of the cr_rect_id[i], cr_associated_rect_id [i], and cr_rect_group_id[i] syntax elements.

cr_associated_rect_id_present_flag[i] equal to 1 specifies that the cr_associated_rect_id[i] syntax elements are present. cr_associated_rect_id_present_flag[i] equal to 0 specifies that the cr_associated_rect_id[i] syntax elements are not present.

cr_associated_rect_id[i] indicates the ID of an associated primary rectangle of the i-th rectangle. The length of the syntax element is cr_rect_id_len bits.

It is a requirement of bitstream conformance that cr_associated_rect_id[i] equal cr_rect_id[j] for some value of j in 0 . . . cr_num_rects_minus1.

When not present, the value of cr_associated_rect_id[i] is undefined.

cr_rect_group_id[i] indicates the group ID of the i-th rectangle. The length of the syntax element is cr_rect_id_len bits. When not present, the value of cr_rect_group_id[i] is inferred to be equal to 0.

In additional embodiments, different enable and/or presence flags may be used. For example, for cr_associated_rect_id[i], a single presence flag can be used, instead of having separate enable flags and presence flag. The presence of the cr_associated_rect_id[i] syntax element can be restricted based on the rectangle type, for example, it can be sent only for when cr_rect_type_idc[i] indicates the CR_ALPHA, CR_DEPTH, or CR_OBJECT_MASK types. Separate syntax elements could be signalled to indicate the length of the cr_associated_rect_id[i] and cr_rect_group_id[i] syntax elements, rather than using the same value signaled for the length of cr_rect_id[i].

### Constituent Rectangle Nesting (CRN) SEI Message

The constituent rectangles SEI message included in JVET-AH2032 enables composition of multiple rectangles within a coded picture and provides information about the rectangles, including ID, type, text description, location, and size.

The VVC scalable nesting SEI message provides the capability to specify that one or more SEI messages applies to one or more subpictures. Various embodiments propose adding a similar capability to specify that one or more SEI messages applies to one or more constituent rectangles.

The proposed functionality is useful, for example, for a coded picture including multiple alpha channel constituent rectangles along with texture constituent rectangles, by enabling an alpha channel info SEI message to be applied to the multiple alpha channel constituent rectangles.

The constituent rectangles nesting (CRN) SEI message includes syntax to indicate a set of constituent rectangles for which a list of SEI messages applies. The CRN SEI message may optionally be a scalable-nested SEI message, e.g., included in the VVC scalable nesting (SN) SEI message. If the CRN SEI message is a scalable-nested SEI message, the CR-nested SEI messages apply to the identified CRs in the set of layers identified in the SN SEI message. If the CRN SEI is not a scalable-nested SEI message, the CR-nested SEI messages apply to the identified CRs in the current layer including the CRN SEI message.

Syntax and semantics for the SEI message is provided below.

| | Descriptor |
|---|---|
| constituent_rectangle_nesting( payloadSize ) { | |
| crn_num_rects_minus1 | ue(v) |
| crn_rect_id_len_minus1 | ue(v) |
| for( i = 0; i <= crn_num_crs_minus1; i++ ) | |
| crn_rect_id[ i ] | u(v) |
| crn_num_seis_minus1 | ue(v) |
| while( !byte_aligned( ) ) | |
| crn_zero_bit /* equal to 0 */ | u(1) |
| for( i = 0; i <= crn_num_seis_minus1; i++ ) | |
| crn_sei_message( ) | |
| } | |

The constituent rectangle nesting (CRN) SEI message provides a mechanism to associate SEI messages with specific sets of constituent rectangles. A CRN SEI message includes one or more SEI messages. The SEI messages included in the constituent rectangle nesting SEI message are referred to as the CR-nested SEI messages.

A CRN SEI message shall not be present in a current picture unit (PU) unless there is an CR SEI message in the current PU or in a PU that precedes the current PU in decoding order within the current CLVS.

When a PU includes both an CRN SEI message and a CR SEI message, the CR SEI message shall precede the CRN SEI message in decoding order.

Use of this SEI message requires the definition of the following variables:
The layers to which the CRN SEI message applies, denoted herein as NestedLayers

Use of this SEI message requires the definition of the crn_sei_message( ) syntax structure, which specifies a CR-nested SEI message and shall include the payload type value, the number of bytes in the SEI message payload, and the SEI message payload.

crn_num_rects_minus1 plus 1 specifies the number of constituent rectangles in each picture in the NestedLayers to which the CR-nested SEI messages apply. The value of crn_num_rects_minus1 shall be less than or equal to the value of cr_num_rects_minus1 in the CR SEI referred to by the pictures.

It is a requirement of bitstream conformance that the value of cr_num_rects_minus1 shall be the same in all CR SEI messages for all layers in NestedLayers.

crn_rect_id_len_minus1 plus 1 specifies the number of bits used to represent the syntax element crn_rect_id[i]. The value of crn_rect_id_len_minus1 shall be in the range of 0 to 15, inclusive.

crn_rect_id[i] indicates the rect ID of the i-th constituent rectangle in each picture in the NestedLayers to which the CR-nested SEI messages apply. The length of the crn_rect_id[i] syntax element is crn_rect_id_len_minus1+1 bits.

crn_num_seis_minus1 plus 1 specifies the number of CR-nested SEI messages. The value of crn_num_seis_minus1 shall be in the range of 0 to 63, inclusive.

crn_zero_bit shall be equal to 0.

Semantics are also provided for the usage of the CRN SEI message by the VVC standard.

Use of the constituent rectangle nesting SEI message in VVC

The semantics of a CR-nested SEI message apply individually to each constituent rectangle identified by the values of cr_rect[i] instead of a decoded picture or cropped decoded picture.

It is a requirement of bitstream conformance that the CR-nested SEI messages shall have payloadType equal to any of the following:
4 (user data registered)
5 (user data unregistered)
165 (alpha channel information)
177 (depth representation information)
202 (annotated regions)
217 (object mask information)
137 (mastering display colour volume)
142 (colour transform information)
144 (content light level information)
147 (alternative transfer characteristics information)
148 (ambient viewing environment information)
149 (content colour volume)
179 (multiview acquisition information)
218 (modality information)
210 (neural network post filter characteristics)
211 (neural network post filter activation)
219 (text description)
XXX (packed regions information)

For purposes of interpretation of the constituent rectangle nesting SEI message the following variables are specified:
The variables NestedLayers is derived as follows:
When the constituent rectangle nesting SEI message is a scalable-nested SEI message the following applies:
When sn_ols_flag is equal to 1, NestedLayers are the layers in the OLSs to which the scalable-nested SEI messages apply.
Otherwise (sn_ols_flag is equal to 0), NestedLayers are the layers to which the scalable-nested SEI messages apply.

Otherwise (the CRN SEI is not a scalable-nested SEI message) the following applies:
NestedLayers is the current layer.
The syntax structure crn_sei_message( ) is set equal to sei_message( ).

### Alternative Syntax and Semantics for Constituent Rectangle Nesting SEI Message

Alternative syntax and semantics for VSEI are provided below. Above, the crn_sei_message( ) syntax structure is used to signal the contents of the CR-nested SEI messages, with the syntax structure defined by VVC as being the sei_message( ) syntax structure. Other codec specifications could also provide an interface syntax structure for use of the CRN SEI message.

In this alternative, the crn_sei_msg_byte[i][j] syntax element is used to signal in the contents of the CR-nested SEI messages, as defined in the VVC user interface semantics.

The relevant portion of the alternative SEI message syntax and semantics are provided below.

| | Descriptor |
|---|---|
| constituent_rectangle_nesting( payloadSize ) { | |
| ... | |
| for( i = 0; i <= crn_num_seis_minus1; i++ ) | |
| for( j = 0; j < CrnSeiMsgSize[ i ]; j++ ) | |
| crn_sei_msg_byte[ i ][ j ] | b(8) |
| } | |

crn_sei_msg_byte[i][j] is the j-th byte of the i-th CR-nested SEI message.

Corresponding modifications for the alternative semantics for the usage of the CRN SEI message in VVC are provided below.

For purposes of interpretation of the constituent rectangles nesting SEI message the following variables are specified:
CrnSeiMsgSize[i] is set equal to the sum of the count of payload_type_byte syntax elements of the i-th CR-nested SEI message, the count of payload_size_byte syntax elements of the i-th CR-nested SEI message, and payloadSize of the i-th CR-nested SEI message.

The sequence of bytes crn_sei_msg_byte[i][j] for the values of j in the range of 0 to CrnSeiMsgSize[i]−1, inclusive, shall conform to the sei_message( ) syntax structure.

Modify the Semantics of the Alpha Channel Information, Depth Representation Info, and Multiview Acquisition Information SEI Messages to Enable their Use with Constituent Rectangles

Various embodiments propose to modify the semantics of the alpha channel information (ACI), depth representation info (DRI), and multiview acquisition information (MAI) SEI messages in VSEI to enable them to be used with constituent rectangles. The object mask information SEI message semantics can also modified to allow use with constituent rectangles.

One feature of the proposed embodiments is to modify the requirement in the current VSEI specification that requires presence of the SDI SEI message in the CVS to use the ACI, DRI, or MAI SEI messages. The requirement is proposed to be modified to require either the presence of the SDI SEI message or the CR SEI message in the CVS.

When an ACI or DRI applies to a picture to which a CR SEI also applies, the ACI or DRI SEI message applies to the constituent rectangles for which cr_rect_type_idc[i] is equal to 1 (CR_ALPHA) or 2 (CR_DEPTH), respectively, in the current layer.

The associated primary constituent rectangle is determined by the cr_associated_rect_idc[i] syntax element, when present. When not present, the associated constituent rectangle is provided via external means.

With the proposal, the CR SEI message indicating one constituent rectangle can be used instead of the SDI SEI message to enable an alpha or depth picture layer to be coded in a VVC bitstream without the presence of an associated primary picture layer in the bitstream.

The modified semantics for the MAI, DRI, and ACI SEI messages are provided below:

### Multiview Acquisition Information SEI Message Semantics

The multiview acquisition information (MAI) SEI message specifies various parameters of the acquisition environment for the layers that may be present in the current CVS, i.e., the CVS containing the MAI SEI message. Specifically, intrinsic and extrinsic camera parameters are specified. These parameters could be used for processing the decoded views prior to rendering on a 3D display.

When an MAI SEI message is present in any AU of a CVS, an MAI SEI message shall be present for the first AU of the CVS. All MAI SEI messages in a CVS shall have the same content.

When a CVS an SDI SEI message with sdi_multiview_info_flag equal to 1 and an MAI SEI message, the CVS shall not contain a CR SEI message. When a CVS does not contain an SDI SEI message with sdi_multiview_info_flag equal to 1 or the CVS does not contain a CR SEI message, the CVS shall not contain an MAI SEI message.

When an AU contains both an SDI SEI message and an MAI SEI message, the SDI SEI message shall precede the MAI SEI message in decoding order.

When a PU contains both a CR SEI message and an MAI SEI message, the CR SEI message shall precede the MAI SEI message in decoding order.

Some of the views for which the MAI is included in an MAI SEI message may not be present in the current CVS.

If the CVS contains an SDI SEI message with sdi_multiview_info_flag equal to 1, in the semantics below, syntax elements and variables with index i refer to the syntax elements and variables that apply to the i-th view in the current CVS specified by the SDI SEI message, i.e., the view with view identifier equal to ViewId[i]. Otherwise in the semantics below, syntax elements and variables with index i refer to the syntax elements and variables that apply to any j-th constituent rectangle for which i=cr_rect_group_id[j] in any layer to which the MAI SEI message applies. NumViews is set equal to the greatest value of cr_rect_group_id[j] in any layer to which the MAI SEI message applies.

The extrinsic camera parameters are specified according to a right-handed coordinate system, where the upper left corner of the image is the origin, i.e., the (0, 0) coordinate, with the other corners of the image having non-negative coordinates. With these specifications, a 3-dimensional world point, wP=[x y z] is mapped to a 2-dimensional camera point, cP[i]=[u v 1], for the i-th camera according to:

$$s * c P [ i ] = A [ i ] * {R}^{- 1} [ i ] * ( w P - T [ i ] ) \qquad ( 1 )$$

where A[i] denotes the intrinsic camera parameter matrix, R−1[i] denotes the inverse of the rotation matrix R[i], T[i] denotes the translation vector and s (a scalar value) is an arbitrary scale factor chosen to make the third coordinate of cP[i] equal to 1. The elements of A[i], R[i] and T[i] are determined according to the syntax elements signalled in this SEI message and as specified below.

intrinsic_param_flag equal to 1 indicates the presence of intrinsic camera parameters. intrinsic_param_flag equal to 0 indicates the absence of intrinsic camera parameters.

extrinsic_param_flag equal to 1 indicates the presence of extrinsic camera parameters. extrinsic_param_flag equal to 0 indicates the absence of extrinsic camera parameters.

num_views_minus1 plus 1 specifies the number of views for which the MAI is included in the MAI SEI message. The value of num_views_minus1 shall be equal to NumViews−1.

intrinsic_params_equal_flag equal to 1 indicates that the intrinsic camera parameters are equal for all cameras and only one set of intrinsic camera parameters is present. intrinsic_params_equal_flag equal to 0 indicates that the intrinsic camera parameters are different for each camera and that a set of intrinsic camera parameters is present for each camera.

prec_focal_length specifies the exponent of the maximum allowable truncation error for focal_length_x[i] and focal_length_y[i] as given by 2−prec_focal_length. The value of prec_focal_length shall be in the range of 0 to 31, inclusive.

prec_principal_point specifies the exponent of the maximum allowable truncation error for principal_point_x[i] and principal_point_y[i] as given by 2−prec_principal_point. The value of prec_principal_point shall be in the range of 0 to 31, inclusive.

prec_skew_factor specifies the exponent of the maximum allowable truncation error for skew factor as given by 2−prec_skew_factor. The value of prec_skew_factor shall be in the range of 0 to 31, inclusive.

sign_focal_length_x[i] equal to 0 indicates that the sign of the focal length of the i-th camera in the horizontal direction is positive. sign_focal_length_x[i] equal to 1 indicates that the sign is negative.

exponent_focal_length_x[i] specifies the exponent part of the focal length of the i-th camera in the horizontal direction. The value of exponent_focal_length_x[i] shall be in the range of 0 to 62, inclusive. The value 63 is reserved for future use by ITU-T ISO/IEC. Decoders shall treat the value 63 as indicating an unspecified focal length.

mantissa_focal_length_x[i] specifies the mantissa part of the focal length of the i-th camera in the horizontal direction. The length of the mantissa_focal_length_x[i] syntax element in units of bits is variable and determined as follows:

If exponent_focal_length_x[i] is equal to 0, the length is Max(0, prec_focal_length−30).

Otherwise (exponent_focal_length_x[i] is in the range of 0 to 63, exclusive), the length is Max(0, exponent_focal_length_x[i]+prec_focal_length−31).

sign_focal_length_y[i] equal to 0 indicates that the sign of the focal length of the i-th camera in the vertical direction is positive. sign_focal_length_y[i] equal to 1 indicates that the sign is negative.

exponent_focal_length_y[i] specifies the exponent part of the focal length of the i-th camera in the vertical direction. The value of exponent_focal_length_y[i] shall be in the range of 0 to 62, inclusive. The value 63 is reserved for future use by ITU-T ISO/IEC. Decoders shall treat the value 63 as indicating an unspecified focal length.

mantissa_focal_length_y[i] specifies the mantissa part of the focal length of the i-th camera in the vertical direction.

The length of the mantissa_focal_length_y[i] syntax element in units of bits is variable and determined as follows:

If exponent_focal_length_y[i] is equal to 0, the length is Max(0, prec_focal_length−30).

Otherwise (exponent_focal_length_y[i] is in the range of 0 to 63, exclusive), the length is Max(0, exponent_focal_length_y[i]+prec_focal_length−31).

sign_principal_point_x[i] equal to 0 indicates that the sign of the principal point of the i-th camera in the horizontal direction is positive. sign_principal_point_x[i] equal to 1 indicates that the sign is negative.

exponent_principal_point_x[i] specifies the exponent part of the principal point of the i-th camera in the horizontal direction. The value of exponent_principal_point_x[i] shall be in the range of 0 to 62, inclusive. The value 63 is reserved for future use by ITU-T|ISO/IEC. Decoders shall treat the value 63 as indicating an unspecified principal point.

mantissa_principal_point_x[i] specifies the mantissa part of the principal point of the i-th camera in the horizontal direction. The length of the mantissa_principal_point_x[i] syntax element in units of bits is variable and is determined as follows:

If exponent_principal_point_x[i] is equal to 0, the length is Max(0, prec_principal_point−30).

Otherwise (exponent_principal_point_x[i] is in the range of 0 to 63, exclusive), the length is Max(0, exponent_principal_point_x[i]+prec_principal_point−31).

sign_principal_point_y[i] equal to 0 indicates that the sign of the principal point of the i-th camera in the vertical direction is positive. sign_principal_point_y[i] equal to 1 indicates that the sign is negative.

exponent_principal_point_y[i] specifies the exponent part of the principal point of the i-th camera in the vertical direction. The value of exponent_principal_point_y[i] shall be in the range of 0 to 62, inclusive. The value 63 is reserved for future use by ITU-T|ISO/IEC. Decoders shall treat the value 63 as indicating an unspecified principal point.

mantissa_principal_point_y[i] specifies the mantissa part of the principal point of the i-th camera in the vertical direction. The length of the mantissa_principal_point_y[i] syntax element in units of bits is variable and is determined as follows:

If exponent_principal_point_y[i] is equal to 0, the length is Max(0, prec_principal_point−30).

Otherwise (exponent_principal_point_y[i] is in the range of 0 to 63, exclusive), the length is Max(0, exponent_principal_point_y[i]+prec_principal_point−31).

sign_skew_factor[i] equal to 0 indicates that the sign of the skew factor of the i-th camera is positive.

sign_skew_factor[i] equal to 1 indicates that the sign is negative.

exponent_skew_factor[i] specifies the exponent part of the skew factor of the i-th camera. The value of exponent_skew_factor[i] shall be in the range of 0 to 62, inclusive. The value 63 is reserved for future use by ITU-T|ISO/IEC. Decoders shall treat the value 63 as indicating an unspecified skew factor.

mantissa_skew_factor[i] specifies the mantissa part of the skew factor of the i-th camera. The length of the mantissa_skew_factor[i] syntax element in units of bits is variable and determined as follows:

If exponent_skew_factor[i] is equal to 0, the length is Max(0, prec_skew_factor−30).

Otherwise (exponent_skew_factor[i] is in the range of 0 to 63, exclusive), the length is Max(0, exponent_skew_factor[i]+prec_skew_factor−31).

The intrinsic matrix A[i] for i-th camera is represented by

$$[ \begin{matrix}focalLengthX [ i ] & skewFactor [ i ] & principalPointX [ i ] \\ 0 & focalLengthY [ i ] & principalPointY [ i ] \\ 0 & 0 & 1\end{matrix} ] \qquad ( 2 )$$

prec_rotation_param specifies the exponent of the maximum allowable truncation error for rE[i][j][k] as given by 2−prec_rotation_param. The value of prec_rotation_param shall be in the range of 0 to 31, inclusive.

prec_translation_param specifies the exponent of the maximum allowable truncation error for tE[i][j](refer to Equation 1) as given by 2−prec_translation_param. The value of prec_translation_param shall be in the range of 0 to 31, inclusive.

sign_r[i][j][k] equal to 0 indicates that the sign of (j, k) component of the rotation matrix for the i-th camera is positive. sign_r[i][j][k] equal to 1 indicates that the sign is negative.

exponent_r[i][j][k] specifies the exponent part of (j, k) component of the rotation matrix for the i-th camera. The value of exponent_r[i][j][k] shall be in the range of 0 to 62, inclusive. The value 63 is reserved for future use by ITUT|ISO/IEC. Decoders shall treat the value 63 as indicating an unspecified rotation matrix.

mantissa_r[i][j][k] specifies the mantissa part of (j, k) component of the rotation matrix for the i-th camera. The length of the mantissa_r[i][j][k] syntax element in units of bits is variable and determined as follows:

If exponent_r[i] is equal to 0, the length is Max(0, prec_rotation_param−30).

Otherwise (exponent_r[i] is in the range of 0 to 63, exclusive), the length is Max(0, exponent_r[i]+prec_rotation_param−31).

The rotation matrix R[i] for i-th camera is represented as follows:

$$[ \begin{matrix}rE [ i ] [ 0 ] [ 0 ] & rE [ i ] [ 0 ] [ 1 ] & rE [ i ] [ 0 ] [ 2 ] \\ rE [ i ] 1 ] [ 0 ] & rE [ i ] [ 1 ] [ 1 ] & rE [ i ] [ 1 ] [ 2 ] \\ rE [ i ] [ 2 ] [ 0 ] & rE [ i ] [ 2 ] [ 1 ] & rE [ i ] [ 2 ] [ 2 ]\end{matrix} ] \qquad ( 3 )$$

sign_t[i][j] equal to 0 indicates that the sign of the j-th component of the translation vector for the i-th camera is positive. sign_t[i][j] equal to 1 indicates that the sign is negative.

exponent_t[i][j] specifies the exponent part of the j-th component of the translation vector for the i-th camera. The value of exponent_t[i]i[j] shall be in the range of 0 to 62, inclusive. The value 63 is reserved for future use by ITU-T|ISO/IEC. Decoders shall treat the value 63 as indicating an unspecified translation vector.

mantissa_t[i][j] specifies the mantissa part of the j-th component of the translation vector for the i-th camera. The length v of the mantissa_t[i][j] syntax element in units of bits is variable and is determined as follows:

If exponent_t[i] is equal to 0, the length v is set equal to Max(0, prec_translation_param−30).

Otherwise (0<exponent_t[i]<63), the length v is set equal to Max(0, exponent_t[i]+prec_translation_param−31).

The translation vector T[i] for the i-th camera is represented by:

$$[ \begin{matrix}t E [ i ] [ 0 ] \\ t E [ i ] [ 1 ] \\ t E [ i ] [ 2 ]\end{matrix} ] \qquad ( 4 )$$

The association between the camera parameter variables and corresponding syntax elements is specified in Table 1. Each component of the intrinsic and rotation matrices and the translation vector is obtained from the variables specified in Table 1 as the variable x computed as follows:

If e is in the range of 0 to 63, exclusive, x is set equal to (−1)s*2e−31*(1+n÷2v).

Otherwise (e is equal to 0), x is set equal to (−1)s*2-(30+v)*n.

The above specification is similar to that found in IEC 60559:1989.

Table 1 shown below illustrates an association between camera parameter variables and syntax elements:

| x | s | e | n |
|---|---|---|---|
| focalLengthX[ i ] | sign_focal_length_x[ i ] | exponent_focal_length_x[ i ] | mantissa_focal_length_x[ i ] |
| focalLengthY[ i ] | sign_focal_length_y[ i ] | exponent_focal_length_y[ i ] | mantissa_focal_length_y[ i ] |
| principalPointX[ i ] | sign_principal_point_x[ i ] | exponent_principal_point_x[ i ] | mantissa_principal_point_x[ i ] |
| principalPointY[ i ] | sign_principal_point_y[ i ] | exponent_principal_point_y[ i ] | mantissa_principal_point_y[ i ] |
| skewFactor[ i ] | sign_skew_factor[ i ] | exponent_skew_factor[ i ] | mantissa_skew_factor[ i ] |
| rE[ i ][ j ][ k ] | sign_r[ i ][ j ][ k ] | exponent_r[ i ][ j ][ k ] | mantissa_r[ i ][ j ][ k ] |
| tE[ i ][ j ] | sign_t[ i ][ j ] | exponent_t[ i ][ j ] | mantissa_t[ i ][ j ] |

### Depth Representation Information SEI Message Semantics

The syntax elements in the depth representation information (DRI) SEI message specify various parameters for auxiliary pictures of type AUX_DEPTH or constituent rectangles of type CR_DEPTH for the purpose of processing decoded primary and depth pictures or constituent rectangles prior to rendering on a 3D display, such as view synthesis. Specifically, depth or disparity ranges for depth pictures or constituent rectangles are specified.

Use of this SEI message requires the definition of the following variable:
A bit depth for the samples of the luma component, denoted herein by BitDepthY.

When a CVS does not contain an SDI SEI message with sdi_aux_id[i] equal to 2 for at least one value of i or the CVS does not contain a CR SEI, no picture in the CVS shall be associated with a DRI SEI message.

When an AU contains both an SDI SEI message with sdi_aux_id[i] equal to 2 for at least one value of i and a DRI SEI message, the SDI SEI message shall precede the DRI SEI message in decoding order.

When an AU contains both a CR SEI message with cr_rect_type_idc[i] equal to 2 for at least value of i and a DRI SEI message, the CR SEI message shall precede the DRI SEI message in decoding order.

When a CVS containing an SDI SEI message with sdi_aux_id[i] equal to 2 for at least one value of is present, the DRI SEI message shall be associated with one or more layers that are indicated as depth auxiliary layers by an SDI SEI message.

When a DRI message applies to a picture to which an CR SEI message also applies, the DRI SEI message is associated with the constituent rectangles for which cr_rect_type_idc[i] is equal to 2.

The following semantics apply separately to each nuh_layer_id targetLayerId among the nuh_layer_id values to which the DRI SEI message applies.

When an access unit contains an auxiliary picture that is indicated as a depth auxiliary layer by an SDI SEI message, the pictures is a depth picture.

If the CVS does not contain an SDI SEI message with sdi_aux_id[targetLayerId] equal to 2, the associated primary picture is provided via external means.

If CR SEI message applies to the picture, an i-th constituent rectangle is a depth constituent rectangle if cr_rect_type_idc[i] is equal to 2. A j-th constituent rectangle is an associated primary constituent rectangle of the i-th constituent rectangle if cr_associated_rect_idc[i] is equal to j. If cr_associated_rect_idc[i] is undefined, the associated constituent rectangle of the i-th constituent rectangle is provided via external means.

When present, the DRI SEI message may be included in any access unit. It is recommended that, when present, the SEI message is included for the purpose of random access in an access unit in which the coded picture with nuh_layer_id equal to targetLayerId is an IRAP picture.

The information indicated in the SEI message applies to all the pictures with nuh_layer_id equal to targetLayerId from the access unit containing the SEI message up to but excluding the next picture, in decoding order, associated with a DRI SEI message applicable to targetLayerId or to the end of the CLVS of the nuh_layer_id equal to targetLayerId, whichever is earlier in decoding order.

z_near_flag equal to 0 specifies that the syntax elements specifying the nearest depth value are not present in the syntax structure. z_near_flag equal to 1 specifies that the syntax elements specifying the nearest depth value are present in the syntax structure.

z_far_flag equal to 0 specifies that the syntax elements specifying the farthest depth value are not present in the syntax structure. z_far_flag equal to 1 specifies that the syntax elements specifying the farthest depth value are present in the syntax structure.

d_min_flag equal to 0 specifies that the syntax elements specifying the minimum disparity value are not present in the syntax structure. d_min_flag equal to 1 specifies that the syntax elements specifying the minimum disparity value are present in the syntax structure.

d_max_flag equal to 0 specifies that the syntax elements specifying the maximum disparity value are not present in the syntax structure. d_max_flag equal to 1 specifies that the syntax elements specifying the maximum disparity value are present in the syntax structure.

depth_representation_type specifies the representation definition of decoded luma samples of depth pictures or constituent rectangles as specified in Table. In Table, disparity specifies the horizontal displacement between two texture views and Z value specifies the distance from a camera. The value of depth_representation_type shall be in the range of 0 to 3, inclusive, in bitstreams conforming to this version of this Specification. The values of 4 to 15, inclusive, for depth_representation_type are reserved for future use by ITU-T|ISO/IEC. Although the value of depth_representation_type is required to be in the range of 0 to 3, inclusive, in this version of this Specification, decoders shall also allow values of depth_representation_type in the range of 4 to 15, inclusive, to appear in the syntax. Decoders conforming to this version of this Specification shall ignore the bits that follow a value of depth_representation_type in the range of 4 to 15, inclusive, in the depth representation information SEI message.

The variable maxVal is set equal to (1<<BitDepthY)−1.

Table 2 shown below illustrates a definition of depth_representation_type

| depth_representation_type | Interpretation |
|---|---|
| 0 | Each decoded luma sample value of an depth picture represents an |
| | inverse or constituent rectangle of Z value that is uniformly quantized |
| | into the range of 0 to maxVal, inclusive. |
| | When z_far_flag is equal to 1, the luma sample value equal to 0 |
| | represents the inverse of ZFar (specified below). When z_near_flag is |
| | equal to 1, the luma sample value equal to maxVal represents the |
| | inverse of ZNear (specified below). |
| 1 | Each decoded luma sample value of an depth picture or constituent |
| | rectangle represents disparity that is uniformly quantized into the range |
| | of 0 to maxVal, inclusive. |
| | When d_min_flag is equal to 1, the luma sample value equal to 0 |
| | represents DMin (specified below). When d_max_flag is equal to 1, the |
| | luma sample value equal to maxVal represents DMax (specified below). |
| 2 | Each decoded luma sample value of an depth picture or constituent |
| | rectangle represents a Z value uniformly quantized into the range of 0 |
| | to maxVal, inclusive. |
| | When z_far_flag is equal to 1, the luma sample value equal to 0 |
| | corresponds to ZFar (specified below). When z_near_flag is equal to 1, |
| | the luma sample value equal to maxVal represents ZNear (specified |
| | below). |
| 3 | Each decoded luma sample value of an depth picture or constituent |
| | rectangle represents a nonlinearly mapped disparity, normalized in range |
| | from 0 to maxVal, as specified by |
| | depth_nonlinear_representation_num_minus1 and |
| | depth_nonlinear_representation_model[ i ]. |
| | When d_min_flag is equal to 1, the luma sample value equal to 0 |
| | represents DMin (specified below). When d_max_flag is equal to 1, the |
| | luma sample value equal to maxVal represents DMax (specified below). |
| Other values | Reserved for future use |

disparity_ref_viewjid specifies the view identifier for which the disparity values are derived. The value of disparity-refview-id shall be in the range of 0 to 1023, inclusive.

The view identifier of the i-th view in the current CVS is equal to ViewId[i] as specified in the semantics of the SDI SEI message.

disparity_ref_view_id is present only if d_min_flag is equal to 1 or d_max_flag is equal to 1 and is useful for depth_representation_type values equal to 1 and 3.

The variables in the x column of Table 3 are derived from the respective variables in the s, e, n and v columns of Table 3 as follows:

If the value of e is in the range of 0 to 127, exclusive, x is set equal to (−1)s*2e−31*(1+n÷2v).
Otherwise (e is equal to 0), x is set equal to (−1)s*2−(30+v)*n.

The above specification is similar to that found in IEC 60559:1989.

Table 3 shown below illustrates an association between depth parameter variables and syntax elements.

| x | s | e | n | v |
|---|---|---|---|---|
| ZNear | ZNearSign | ZNearExp | ZNearMantissa | ZNearManLen |
| ZFar | ZFarSign | ZFarExp | ZFarMantissa | ZFarManLen |
| DMax | DMaxSign | DMaxExp | DMaxMantissa | DMaxManLen |
| DMin | DMinSign | DMinExp | DMinMantissa | DMinManLen |

The DMin and DMax values, when present, are specified in units of a luma sample width of the associated primary picture of the depth picture.

The units for the ZNear and ZFar values, when present, are identical but unspecified.

depth_nonlinear_representation_num_minus1 plus 2 specifies the number of piece-wise linear segments for mapping of depth values to a scale that is uniformly quantized in terms of disparity. The value of depth_nonlinear_representation_num_minus1 shall be in the range of 0 to 62, inclusive.

depth_nonlinear_representation_model[i] for i ranging from 0 to depth_nonlinear_representation_num_minus1+2, inclusive, specify the piece-wise linear segments for mapping of decoded luma sample values of an depth picture or constituent rectangle to a scale that is uniformly quantized in terms of disparity. The value of depth_nonlinear_representation_model[i] shall be in the range of 0 to 65 535, inclusive. The values of depth_nonlinear_representation_model[0] and depth_nonlinear_representation_model[depth_nonlinear_representation_num_minus1+2] are both inferred to be equal to 0.

When depth_representation_type is equal to 3, an depth picture or constituent rectangle contains non-linearly transformed depth samples. The variable DepthLUT[i], as specified below, is used to transform decoded depth sample values from the non-linear representation to the linear representation, i.e., uniformly quantized disparity values. The shape of this transform is defined by means of line-segment approximation in two-dimensional linear-disparity-to-non-linear-disparity space. The first (0, 0) and the last (maxVal, maxVal) nodes of the curve are predefined. Positions of additional nodes are transmitted in form of deviations (depth_nonlinear_representation_model[i]) from the straight-line curve. These deviations are uniformly distributed along the whole range of 0 to maxVal, inclusive, with spacing depending on the value of depth_nonlinear_representation_num_minus1. The variable DepthLUT[i] for i in the range of 0 to maxVal, inclusive, is specified as follows:

```
    for( k = 0; k <= depth_nonlinear_representation_num_minus1 + 1; k++ ) {
  pos1 = ( maxVal * k ) / (depth_nonlinear_representation_num_minus1 + 2 )
  dev1 = depth_nonlinear_representation_model[ k ]
  pos2 = ( maxVal * ( k + 1 ) ) / (depth_nonlinear_representation_num_minus1 + 2 )
  dev2 = depth_nonlinear_representation_model[ k + 1 ] (5)
  x1 = pos1 − dev1
  y1 = pos1 + dev1
  x2 = pos2 − dev2
  y2 = pos2 + dev2
  for( x = Max( x1, 0 ); x <= Min( x2, maxVal ); x++ )
      DepthLUT[ x ] = Clip3( 0, maxVal, Round( ( ( x − x1 ) * ( y2 − y1 ) ) ÷ ( x2 − x1 ) +
y1 ) )
}
```

When depth_representation_type is equal to 3, DepthLUT[dS] for all decoded luma sample values dS of an depth picture or constituent rectangle in the range of 0 to maxVal, inclusive, represents disparity that is uniformly quantized into the range of 0 to maxVal, inclusive.

### Depth Representation Information Element Semantics

The syntax structure specifies the value of an element in the DRI SEI message.

The depth_rep_info_element(OutSign, OutExp, OutMantissa, OutManLen) syntax structure sets the values of the OutSign, OutExp, OutMantissa and OutManLen variables that represent a floating-point value. When the syntax structure is included in another syntax structure, the variable names OutSign, OutExp, OutMantissa and OutManLen are to be interpreted as being replaced by the variable names used when the syntax structure is included.

da_sign_flag equal to 0 indicates that the sign of the floating-point value is positive. da_sign_flag equal to 1 indicates that the sign is negative. The variable OutSign is set equal to da_sign_flag.

da_exponent specifies the exponent of the floating-point value. The value of da_exponent shall be in the range of 0 to 27-2, inclusive. The value 27-1 is reserved for future use by ITU-T|ISO/IEC. Decoders shall treat the value 27-1 as indicating an unspecified value. The variable OutExp is set equal to da_exponent.

da_mantissa_len_minus1 plus 1 specifies the number of bits in the da_mantissa syntax element. The variable OutManLen is set equal to da_mantissa_len_minus1+1.

da_mantissa specifies the mantissa of the floating-point value. The variable OutMantissa is set equal to da_mantissa.

### Alpha Channel Information SEI Message Semantics

The alpha channel information (ACI) SEI message provides information about alpha channel sample values and post-processing applied to the decoded alpha planes coded in auxiliary pictures of type AUX_ALPHA or constituent rectangles of type CR_ALPHA and one or more associated primary pictures or constituent rectangles.

When a CVS does not contain an SDI SEI message with sdi_aux_id[i] equal to 1 for at least one value of i or the CVS does not contain a CR SEI, no picture in the CVS shall be associated with an ACI SEI message.

When an AU contains both an SDI SEI message with sdi_aux_id[i] equal to 1 for at least one value of i and an ACI SEI message, the SDI SEI message shall precede the ACI SEI message in decoding order.

When an AU contains both a CR SEI message with cr_rect_type_idc[i] equal for at least one value of i and an ACI SEI message, the CR SEI message shall precede the ACI SEI message in decoding order.

When an ACI message applies to a picture to which a CR SEI message also applies, the ACI SEI message is associated with the constituent rectangles for which cr_rect_type_idc[i] is equal to 1.

When an access unit contains an auxiliary picture picA in a layer, with nuh_layer_id equal to nuhLayerIdA, that is indicated as an alpha auxiliary layer by an SDI SEI message, picA is an alpha picture and the alpha channel sample values of picA persist in output order until one or more of the following conditions are true:
The next picture, in output order, with nuh_layer_id equal to nuhLayerIdA is output.
A CLVS containing the auxiliary picture picA ends.
The bitstream ends.
A CLVS of any associated primary layer of the auxiliary picture layer with nuh_layer_id equal to nuhLayerIdA ends.

The following semantics apply separately to each nuh_layer_id targetLayerId among the nuh_layer_id values to which the ACI SEI message applies.

If the CVS does not contain an SDI SEI message with sdi_aux_id[targetLayerId] equal to 1, the associated primary picture is provided via external means. If a CR SEI message applies to the picture, an i-th constituent rectangle is an alpha constituent rectangle if cr_rect_type_idc[i] is equal to 1. A j-th constituent rectangle is an associated primary constituent rectangle of the i-th constituent rectangle if cr_associated_rect_idc[i] is equal to j. If cr_associated_rect_idc[i] is undefined, the associated constituent rectangle of the i-th constituent rectangle is provided via external means.

alpha_channel_cancel_flag equal to 1 indicates that the SEI message cancels the persistence of any previous ACI SEI message in output order that applies to the current layer. alpha_channel_cancel_flag equal to 0 indicates that ACI follows.

Let currPic be the picture that the ACI SEI message is associated with. The semantics of ACI SEI message persist for the current layer in output order until one or more of the following conditions are true:
A new CLVS of the current layer begins.
The bitstream ends.
A picture in the current layer in an AU associated with an ACI SEI message is output that follows the current picture in output order.

alpha_channel_use_idc equal to 0 indicates that for alpha blending purposes the decoded samples of the associated primary picture or constituent rectangle should be multiplied by the interpretation sample values of the decoded alpha picture or constituent rectangle in the display process after output from the decoding process. alpha_channel_use_idc equal to 1 indicates that for alpha blending purposes the decoded samples of the associated primary picture or constituent rectangle should not be multiplied by the interpretation sample values of the decoded alpha picture or constituent rectangle in the display process after output from the decoding process. alpha_channel_use_idc equal to 2 indicates that the usage of the alpha picture or constituent rectangle is unspecified. Values greater than 2 for alpha_channel_use_idc are reserved for future use by ITU-T|ISO/IEC. When not present, the value of alpha_channel_use_idc is inferred to be equal to 2. Decoders shall ignore alpha channel information SEI messages in which alpha_channel_use_idc is greater than 2.

alpha_channel_bit_depth_minus8 plus 8 specifies the bit depth of the samples of the luma sample array of the alpha picture or constituent rectangle. alpha_channel_bit_depth_minus8 plus 8 shall be equal to the bit depth of the associated primary picture or constituent rectangle.

alpha_transparent_value specifies the interpretation sample value of a decoded alpha picture or constituent rectangle luma sample for which the associated luma and chroma samples of the primary coded picture or constituent rectangle are considered transparent for purposes of alpha blending. The number of bits used for the representation of the alpha_transparent_value syntax element is alpha_channel_bit_depth_minus8+9.

alpha_opaque_value specifies the interpretation sample value of a decoded alpha picture or constituent rectangle luma sample for which the associated luma and chroma samples of the primary coded picture or constituent rectangle are considered opaque for purposes of alpha blending. The number of bits used for the representation of the alpha_opaque_value syntax element is alpha_channel_bit_depth_minus8+9.

A value of alpha_opaque_value that is equal to alpha_transparent_value indicates that the alpha coded picture or constituent rectangle is not intended for alpha blending purposes.

For alpha blending purposes, alpha_opaque_value can be greater than alpha_transparent_value or it can be less than or equal to alpha_transparent_value.

alpha_channel_incr_flag equal to 0 indicates that the interpretation sample value for each decoded alpha picture or constituent rectangle luma sample value is equal to the decoded alpha picture sample value for purposes of alpha blending. alpha_channel_incr_flag equal to 1 indicates that, for purposes of alpha blending, after decoding the alpha picture or constituent rectangle samples, any alpha picture or constituent rectangle luma sample value that is greater than Min(alpha_opaque_value, alpha_transparent_value) should be increased by one to obtain the interpretation sample value for the alpha picture or constituent rectangle sample and any alpha picture or constituent rectangle luma sample value that is less than or equal to Min(alpha_opaque_value, alpha_transparent_value) should be used, without alteration, as the interpretation sample value for the decoded alpha picture or constituent rectangle sample value.

When alpha_transparent_value is equal to alpha_opaque_value or Log 2(Abs(alpha_opaque_value−alpha_transparent_value)) does not have an integer value, alpha_channel_incr_flag shall be equal to 0.

alpha_channel_clip_flag equal to 0 indicates that no clipping operation is applied to obtain the interpretation sample values of the decoded alpha picture or constituent rectangle. alpha_channel_clip_flag equal to 1 indicates that the interpretation sample values of the decoded alpha picture or constituent rectangle are altered according to the clipping process described by the alpha_channel_clip_type_flag syntax element.

alpha_channel_clip_type_flag equal to 0 indicates that, for purposes of alpha blending, after decoding the alpha picture samples, any alpha picture or constituent rectangle luma sample that is greater than (alpha_opaque_value+alpha_transparent_value)/2 is set equal to Max(alpha_transparent_value, alpha_opaque_value) to obtain the interpretation sample value for the alpha picture or constituent rectangle luma sample and any alpha picture luma sample that is less or equal than (alpha_opaque_value+alpha_transparent_value)/2 is set equal to Min(alpha_transparent_value, alpha_opaque_value) to obtain the interpretation sample value for the alpha picture luma sample. alpha_channel_clip_type_flag equal to 1 indicates that, for purposes of alpha blending, after decoding the alpha picture samples, any alpha picture or constituent rectangle luma sample that is greater than Max(alpha_transparent_value, alpha_opaque_value) is set equal to Max(alpha_transparent_value, alpha_opaque_value) to obtain the interpretation sample value for the alpha picture or constituent rectangle luma sample and any alpha picture or constituent rectangle luma sample that is less than or equal to Min(alpha_transparent_value, alpha_opaque_value) is set equal to Min(alpha_transparent_value, alpha_opaque_value) to obtain the interpretation sample value for the alpha picture or constituent rectangle luma sample.

When both alpha_channel_incr_flag and alpha_channel_clip_flag are equal to one, the clipping operation specified by alpha_channel_clip_type_flag should be applied first, followed by the alteration specified by alpha_channel_incr_flag, to obtain the interpretation sample value for the alpha picture or constituent rectangle luma sample.

Alpha blending composition is ordinarily performed with a background picture B, a foreground picture F, and a decoded alpha picture A, all of the same size. Assume for purposes of example illustration that the chroma resolutions of B and F, if different from the luma resolution, have been upsampled to the same resolution as the luma. Denote corresponding samples of B, F and A by b, f and a, respectively. Denote luma and chroma samples by subscripts Y, Cb and Cr. Each component, e.g., Y, is also assumed for purposes of example illustration to have the same bit depth in each of the pictures B and F. However, different components, e.g., Y and Cb, can have different bit depths in this example. The samples of pictures B and F may alternatively represent green, blue and red component values, although the equations use the subscripts Y, Cb and Cr for the three components.

Define the variables alphaRange, alphaFwt and alphaBwt for each luma sample aY of the alpha picture A as follows:

$$alphaRange = Abs ( allpha\_opaque \_alpha \_transparent \_value ) \qquad ( 6 )$$

$$alphaFwt = Abs ( {a}_{Y} - alpha\_transparent \_value ) \qquad ( 7 )$$

$$alphaBwt = Abs ( {a}_{Y} - alpha\_opaque \_value ) \qquad ( 8 )$$

A picture format that is often useful for editing or direct viewing, and that is commonly used, is called pre-multiplied-black video. Pre-multiplied-black video has the characteristic that the decoded picture F will appear the same regardless of whether it is viewed directly without alpha blending composition or is alpha blended with a black background. The use of alpha_channel_use_idc equal to 0 corresponds with source video that is not pre-multiplied-black video, and the use of alpha_channel_use_idc equal to 1 corresponds with source video that is pre-multiplied-black video.

An example of operation of the alpha blending composition process to produce a displayed picture D with sample values d from the pictures B and F is as follows:
If alpha_channel_use_idc is equal to 0, the samples d of the displayed picture D are calculated as follows:

$${d}_{Y} = ( alphaFwt * {f}_{Y} + alphaBwt * {b}_{Y} + alphaRange / 2 ) / alphaRange \qquad ( 9 )$$

$${d}_{Cb} = ( alphaFwt * {f}_{Cb} + alphaBwt * {b}_{Cb} + alphaRange / 2 ) / alphaRange \qquad ( 10 )$$

$${d}_{Cr} = ( alphaFwt * {f}_{Cr} + alphaBwt * {b}_{Cr} + alphaRange / 2 ) / alphaRange \qquad ( 11 )$$

Otherwise (alpha_channel_use_idc is equal to 1), the samples d of the displayed picture D are calculated as follows:

$${d}_{Y} = {f}_{Y} + ( alphaBwt * {b}_{Y} + alphaRange / 2 ) / alphaRange \qquad ( 12 )$$

$${d}_{Cb} = {f}_{Cb} + ( alphaBwt * {b}_{Cb} + alphaRange / 2 ) / alphaRange \qquad ( 13 )$$

$${d}_{Cr} = {f}_{Cr} + ( alphaBwt * {b}_{Cr} + alphaRange / 2 ) / alphaRange \qquad ( 14 )$$

In this case, it is expected that the encoder produces its pre-multiplied-black source video picture S with sample values s from some original input picture T with sample values t as expressed by Equations 15 to 17, so that when the decoded picture F is a close approximation of the pre-multiplied-black source video picture S, the cascaded effect of Equations 15 to 17 followed by Equations 12 to 14 is approximately the same as expressed in Equations 9 to 11.

$${s}_{Y} = ( alphaFwt * {t}_{Y} ) / alphaRange \qquad ( 15 )$$

$${s}_{Cb} = ( alphaFwt * {t}_{Cb} ) / alphaRange \qquad ( 16 )$$

$${s}_{Cr} = ( alphaFwt * {t}_{Cr} ) / alphaRange \qquad ( 17 )$$

In the event that the background picture B is represented using green, blue and red component values in a manner such that the colour black is represented by all three component values being equal to 0, when the background picture B is black, the operation expressed by Equations 12 to 14 becomes simply dY=fY, dCb=fCb, and dCr=fCr. This can help to explain the “pre-multiplied black” term, as the expressions in Equations 15 to 17 are referred to as the pre-multiplication for the black background combination.

For the case with alpha_channel_use_idc equal to 1, somewhat modified processing should be applied when the colour representation domain is different from the use of green, blue, and red colour component values, or with the use of a non-zero black level. Unless the colour black is represented by all three component values bY, bCb, and bCr being equal to 0, Equations 12 Error! Reference source not found. to 14 Error! Reference source not found. do not simplify to dY=fY, dCb=fCb, and dCr=fCr for pre-multiplied-black video content.

In the modifications to the ACI and DRI SEI messages, references to auxiliary pictures are replaced with alpha (or depth) pictures or constituent rectangles.

In the MAI SEI message currently in VSEI, camera parameters are sent with an index i, which corresponds to the view with view identifier equal to ViewId[i] in the SDI SEI message. In the proposed modifications, if the MAI applies to a CVS containing multiple layers, each individual layer may have a CR SEI message with different parameters than those in other layers. The camera parameters signalled in the MAI SEI message for index i correspond to a particular constituent rectangle in a particular layer according to a processed defined below:

The variable prevIndex is set equal to 0

For each layer MaiLayer, among all the layers to which the MAI SEI message applies, in increasing value of nuh_layer_id, the following applies:

In the semantics below, syntax elements and variables with index i refer to the syntax elements and variables that apply to j-th constituent rectangle in the layer MaiLayer for which i=prevIndex+cr_rect_id[j].

$$prevIndex is set equal to prevIndex + cr\_num \_rects \_minus1 + 1$$

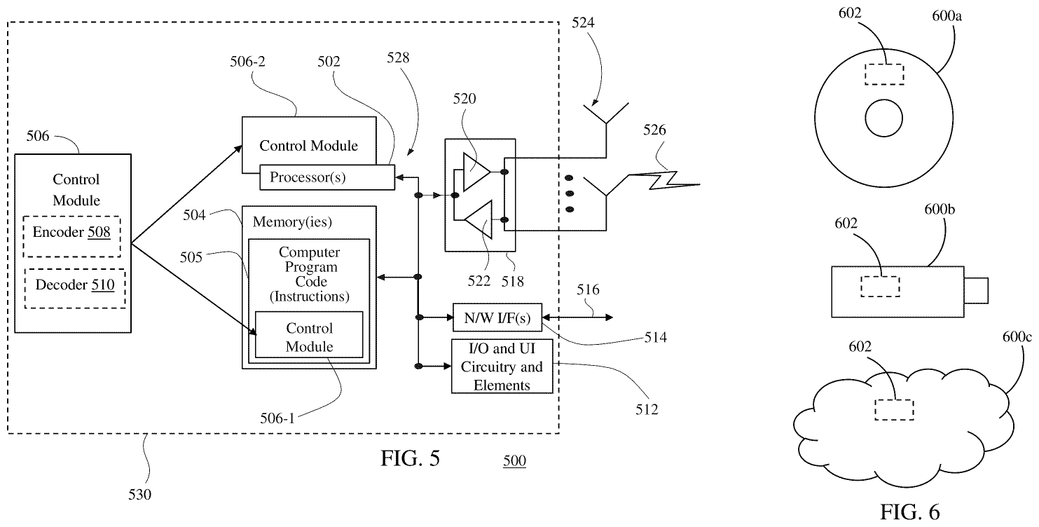

FIG. 5 is an example apparatus 500, which may be implemented in hardware, configured to implement the examples described herein. The apparatus 500 comprises at least one processor 502 (e.g., an FPGA and/or CPU), at least one memory 504 including computer program code 505, the computer program code 505 having instructions to carry out the methods described herein, wherein the at least one memory 504 and the computer program code 505 are configured to, with the at least one processor 502, cause the apparatus 500 to implement circuitry, a process, component, module, or function (implemented with control module 506) to implement the examples described herein, including usages of constituent rectangles in coded video. Optionally included encoder 508 of the control module 506 implements encoding based on the examples described herein, and optionally included decoder 510 implements decoding based on the examples described herein. The at least one memory 504 may be a non-transitory memory, a transitory memory, a volatile memory (e.g. RAM), or a non-volatile memory (e.g., ROM).

The apparatus 500 includes a display and/or I/O interface 512, which includes user interface (UI) circuitry and elements, that may be used to display features or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 500 includes one or more communication e.g. network (N/W) interfaces (I/F(s)) 514. The communication I/F(s) 514 may be wired and/or wireless and communicate over the Internet/other network(s) via any communication technique including via one or more links 516. The communication I/F(s) 514 may comprise one or more transmitters or one or more receivers.

The transceiver 518 comprises one or more transmitters 520 and one or more receivers 522. The transceiver 518 and/or communication I/F(s) 514 may comprise standard well-known components such as an amplifier, filter, frequency-converter, (de)modulator, and encoder/decoder circuitries and one or more antennas, such as antennas 524 used for communication over wireless link 526.

The control module 506 of the apparatus 500 comprises one of or both parts 506-1 and/or 506-2, which may be implemented in a number of ways. The control module 506 may be implemented in hardware as control module 506-1, such as being implemented as part of the at least one processor 502. The control module 506-1 may be implemented also as an integrated circuit or through other hardware such as a programmable gate array. In another example, the control module 506 may be implemented as control module 506-2, which is implemented as computer program code (having corresponding instructions) 505 and is executed by the at least one processor 502. For instance, the at least one memory 504 store instructions that, when executed by the at least one processor 502, cause the apparatus 500 to perform one or more of the operations as described herein. Furthermore, the at least one processor 502, the at least one memory 504, and example algorithms (e.g., as flowcharts and/or signaling diagrams), encoded as instructions, programs, or code, are means for causing performance of the operations described herein.

The apparatus 500 to implement the functionality of control module 506 may correspond to any of the apparatuses depicted herein. Alternatively, apparatus 500 and its elements may not correspond to any of the other apparatuses depicted herein, as apparatus 500 may be part of a self-organizing/optimizing network (SON) node or other node, such as a node in a cloud.

The apparatus 500 may also be distributed throughout the network including within and between apparatus 500 and any network element (such as a base station and/or terminal device and/or user equipment).

Interface 528 enables data communication and signaling between the various items of apparatus 500, as shown in FIG. 5. For example, the interface 528 may be one or more buses such as address, data, or control buses, and may include any interconnection mechanism, such as a series of lines on a motherboard or integrated circuit, fiber optics or other optical communication equipment, and the like. Computer program code (e.g. instructions) 505, including control module 506 may comprise object-oriented software configured to pass data or messages between objects within computer program code 505. The apparatus 500 need not comprise each of the features mentioned, or may comprise other features as well. The various components of apparatus 500 may at least partially reside in a housing 530, or a subset of the various components of apparatus 500 may at least partially be located in different housings, which different housings may include housing 530.

FIG. 6 shows a schematic representation of non-volatile memory media 600a (e.g. computer/compact disc (CD) or digital versatile disc (DVD)) and 600b (e.g. universal serial bus (USB) memory stick) and 600c (e.g. cloud storage for downloading instructions and/or parameters 602 or receiving emailed instructions and/or parameters 602) storing instructions and/or parameters 602 which when executed by a processor allows the processor to perform one or more of the operations of the methods described herein. Instructions and/or parameters 602 may represent or correspond to a non-transitory computer readable medium.

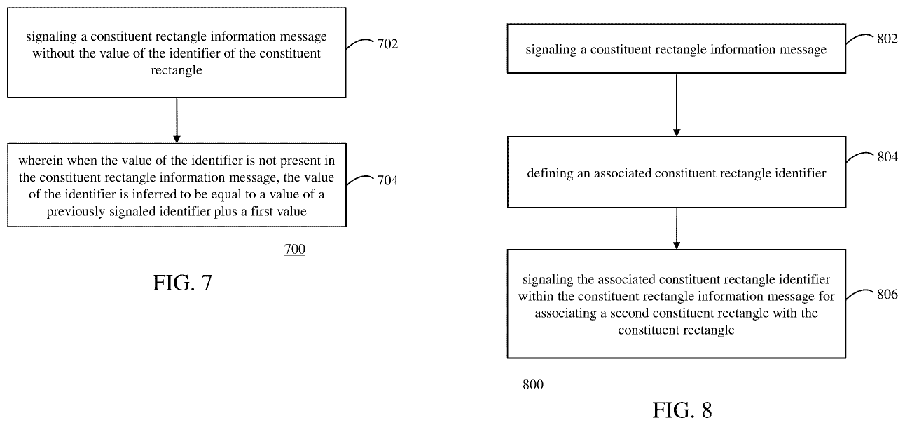

FIG. 7 is an example method 700 performed with an encoder, based on the examples described herein. At 702, the method 700 includes signaling a constituent rectangle information message without the value of the identifier of the constituent rectangle. At 704, the method 700 includes wherein when the value of the identifier is not present in the constituent rectangle information message, the value of the identifier is inferred to be equal to a value of a previously signaled identifier plus a first value. In an example, the first value is equal to 1.

In an example, when an index of the constituent rectangle is equal to zero, the value of the identifier is inferred to be equal to 0.

The method 700 may be performed with an encoding apparatus, such as the apparatus 100, 500, apparatuses depicted in FIG. 3 and FIG. 4, for example, the transmitting apparatus 406 with the encoder 402, or the apparatus 400 with the encoder 402.

FIG. 8 is another example method 800 performed with an encoder, based on the examples described herein. At 802, the method 800 includes signaling a constituent rectangle information message. At 804, the method 800 includes defining an associated constituent rectangle identifier. At 806, the method 800 includes signaling the associated constituent rectangle identifier within the constituent rectangle information message for associating a second constituent rectangle with the constituent rectangle.

The method 800 may be performed with an encoding apparatus, such as the apparatus 100, 500, apparatuses depicted in FIG. 3 and FIG. 4, for example, the transmitting apparatus 406 with the encoder 402, or the apparatus 400 with the encoder 402.

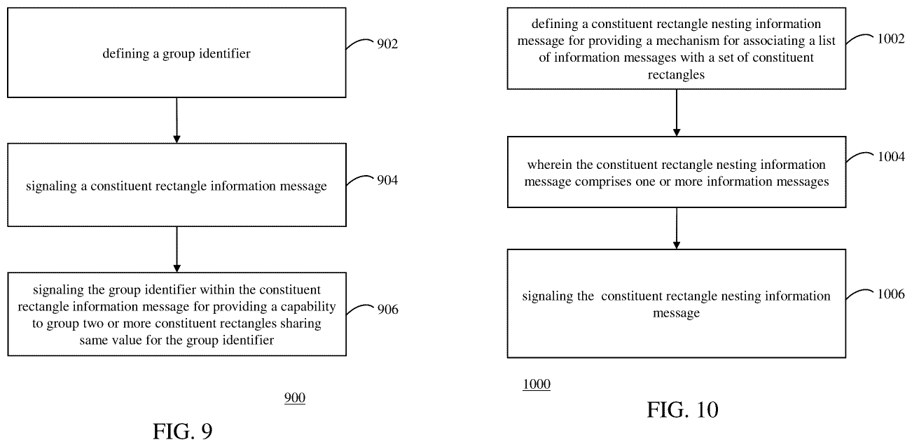

FIG. 9 is yet another example method 900 performed with an encoder, based on the examples described herein. At 902, the method 900 includes defining a group identifier. At 904, the method 900 signaling a constituent rectangle information message. At 906, the method 900 signaling the group identifier within the constituent rectangle information message for providing a capability to group two or more constituent rectangles sharing same value for the group identifier.

The method 900 may be performed with an encoding apparatus, such as the apparatus 100, 500, apparatuses depicted in FIG. 3 and FIG. 4, for example, the transmitting apparatus 406 with the encoder 402, or the apparatus 400 with the encoder 402.

FIG. 10 is still another example method 1000 performed with an encoder, based on the examples described herein. At 1002, the method 1000 includes defining a constituent rectangle nesting information message for providing a mechanism for associating a list of information messages with a set of constituent rectangles. At 1004, the method 1000 includes, wherein the constituent rectangle nesting information message comprises one or more information messages. At 1006, the method 1000 includes signaling the constituent rectangle nesting information message.

The method 1000 may be performed with an encoding apparatus, such as the apparatus 100, 500, apparatuses depicted in FIG. 3 and FIG. 4, for example, the transmitting apparatus 406 with the encoder 402, or the apparatus 400 with the encoder 402.

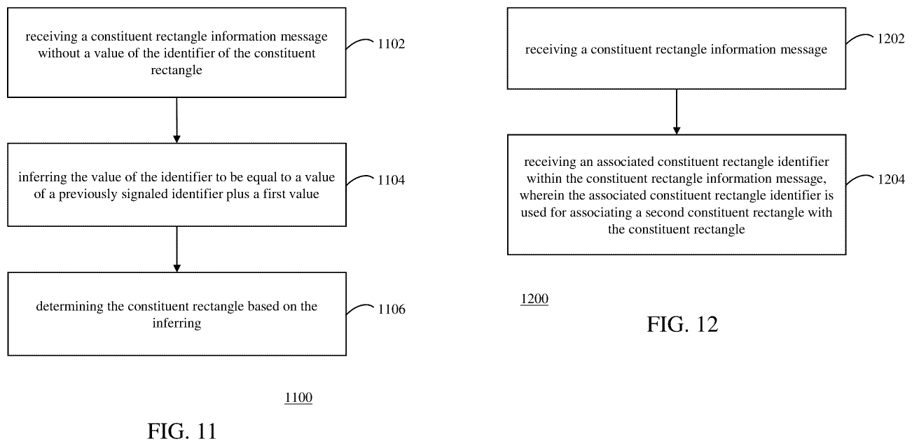

FIG. 11 is an example method 1100 performed with a decoder, based on the example embodiments described herein. At 1102, the method 1100 includes receiving a constituent rectangle information message without a value of the identifier of the constituent rectangle. At 1104, the method 1100 inferring the value of the identifier to be equal to a value of a previously signaled identifier plus a first value. At 1106, the method 1100 determining the constituent rectangle based on the inferring. In an example, the first value is equal to 1.

The method 1100 may be performed with a decoding apparatus, such as the apparatus 100, 500, apparatuses depicted in FIG. 3 and FIG. 4, for example, the receiving apparatus 410 with the decoder 412, or the apparatus 400 with the decoder 412.

FIG. 12 is another example method 1200 performed with a decoder, based on the example embodiments described herein. At 1202, the method 1200 includes receiving a constituent rectangle information message. At 1204, the method 1200 includes receiving an associated constituent rectangle identifier within the constituent rectangle information message, wherein the associated constituent rectangle identifier is used for associating a second constituent rectangle with the constituent rectangle.

The method 1200 may be performed with a decoding apparatus, such as the apparatus 100, 500, apparatuses depicted in FIG. 3 and FIG. 4, for example, the receiving apparatus 410 with the decoder 412, or the apparatus 400 with the decoder 412.

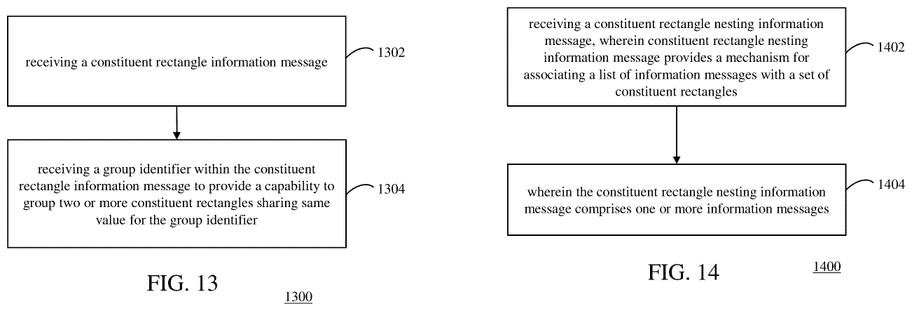

FIG. 13 is yet another example method 1300 performed with a decoder, based on the example embodiments described herein. At 1302, the method 1300 includes receiving a constituent rectangle information message. At 1304, the method 1300 receiving a group identifier within the constituent rectangle information message to provide a capability to group two or more constituent rectangles sharing same value for the group identifier.

The method 1300 may be performed with a decoding apparatus, such as the apparatus 100, 500, apparatuses depicted in FIG. 3 and FIG. 4, for example, the receiving apparatus 410 with the decoder 412, or the apparatus 400 with the decoder 412.

FIG. 14 is still another example method 1400 performed with a decoder, based on the example embodiments described herein. At 1402, the method 1400 includes receiving a constituent rectangle nesting information message, wherein constituent rectangle nesting information message provides a mechanism for associating a list of information messages with a set of constituent rectangles. At 1404, the method 1400 includes wherein the constituent rectangle nesting information message comprises one or more information messages.

The method 1400 may be performed with a decoding apparatus, such as the apparatus 100, 500, apparatuses depicted in FIG. 3 and FIG. 4, for example, the receiving apparatus 410 with the decoder 412, or the apparatus 400 with the decoder 412.

As described above, FIGS. 7 to 14 include flowcharts of an apparatus (e.g. 100, 400, 500, or any other apparatuses described herein), method, and computer program product according to certain example embodiments. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory (e.g., 112 or 504) of an apparatus employing an embodiment of the present invention and executed by processing circuitry (e.g., 110 or 502) of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

A computer program product is therefore defined in those instances in which the computer program instructions, such as computer-readable program code portions, are stored by at least one non-transitory computer-readable storage medium with the computer program instructions, such as the computer-readable program code portions, being configured, upon execution, to perform the functions described above, such as in conjunction with the flowchart(s) of FIGS. 7 to 14. In other embodiments, the computer program instructions, such as the computer-readable program code portions, need not be stored or otherwise embodied by a non-transitory computer-readable storage medium, but may, instead, be embodied by a transitory medium with the computer program instructions, such as the computer-readable program code portions, still being configured, upon execution, to perform the functions described above.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, may be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

In the above, some embodiments have been described with reference to SEI messages. It needs to be understood that embodiments may be similarly realized with any other similar syntax structures, such as metadata OBUs and/or ITU-T T.35 metadata.

In the above, some example embodiments have been described with the help of syntax of the bitstream. It needs to be understood, however, that the corresponding structure and/or computer program may reside at the encoder for generating the bitstream and/or at the decoder for decoding the bitstream.

In the above, some embodiments have been described in relation to particular syntax elements and/or syntax structures. It needs to be understood that corresponding embodiments for encoding may be realized by including encoding steps for creating the particular syntax elements and/or syntax structures. Similarly, it needs to be understood that corresponding embodiments for decoding may be realized by including decoding steps for reading the particular syntax elements and/or syntax structures. Furthermore, when the decoded syntax elements and/or syntax structures imply certain processing, such as certain processing order of SEI messages, corresponding embodiments for decoding may include such processing steps.

In the above, where example embodiments have been described with reference to an encoder, it needs to be understood that the resulting bitstream and the decoder have corresponding elements in them. Likewise, where example embodiments have been described with reference to a decoder, it needs to be understood that the encoder has structure and/or computer program for generating the bitstream to be decoded by the decoder.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Accordingly, the description is intended to embrace all such alternatives, modifications and variances which fall within the scope of the appended claims. Although specific terms are employed herein, they are used in a generic and descriptive sense only and not for purposes of limitation.

It should be understood that the foregoing description is only illustrative. Various alternatives and modifications may be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

References to a ‘computer’, ‘processor’, etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device such as instructions for a processor, or configuration settings for a fixed-function device, gate array or programmable logic device, and the like.

As used herein, the term ‘circuitry’ may refer to any of the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even when the software or firmware is not physically present. This description of ‘circuitry’ applies to uses of this term in this application. As a further example, as used herein, the term ‘circuitry’ would also cover an implementation of merely a processor (or multiple processors) or a portion of a processor and its (or their) accompanying software and/or firmware. The term ‘circuitry’ would also cover, for example and when applicable to the particular element, a baseband integrated circuit or applications processor integrated circuit for a mobile phone or a similar integrated circuit in a server, a cellular network device, or another network device.

Circuitry or Circuit: As used in this application, the term ‘circuitry’ or ‘circuit’ may refer to one or more or all of the following:
(a) hardware-only circuit implementations (such as implementations in only analog and/or digital circuitry); and
(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example, and when applicable to the particular claim element, a baseband integrated circuit or processor integrated circuit for a mobile device or a similar integrated circuit in server, a cellular network device, or other computing or network device.

What is claimed is:

1. An apparatus comprising:
at least one processor; and
at least one memory storing instructions that, when executed by the at least one processor, cause the apparatus at least to perform:
receiving a constituent rectangle information message without a value of an identifier of a constituent rectangle;
inferring the value of the identifier to be equal to a value of a previously signaled identifier plus a first value; and
determining the constituent rectangle based on the inferring.

2. The apparatus of claim 1, wherein the apparatus is further caused to perform: receiving an associated constituent rectangle identifier within the constituent rectangle information message for associating a second constituent rectangle with the constituent rectangle.

3. The apparatus of claim 2, wherein the apparatus is further caused perform:
receiving an enable flag; and
receiving, when the enable flag is set to a second value, a presence flag for the constituent rectangle, wherein the associated constituent rectangle identifier is received when the presence flag is set to a third value.

4. The apparatus of claim 1, wherein the apparatus is further caused to perform:
receiving a group identifier within the constituent rectangle information message, wherein the group identifier provides a capability to group two or more constituent rectangles sharing same value for the group identifier.

5. An apparatus comprising:
at least one processor; and
at least one memory storing instructions that, when executed by the at least one processor, cause the apparatus at least to perform:
receiving a constituent rectangle information message; and
receiving an associated constituent rectangle identifier within the constituent rectangle information message, wherein the associated constituent rectangle identifier is used for associating a second constituent rectangle with a constituent rectangle.

6. The apparatus of claim 5, wherein when a depth representation information message applies to a current picture, the associated constituent rectangle identifier indicates a primary constituent rectangle associated with a constituent rectangle of type depth.

7. The apparatus of claim 5, wherein when an alpha channel information message applies to a current picture, the associated constituent rectangle identifier indicates a primary constituent rectangle associated with a constituent rectangle of type alpha to provide information about alpha channel sample values and post-processing applied to decoded alpha planes coded in the constituent rectangle of type alpha and the associated constituent rectangle.

8. An apparatus comprising:
at least one processor; and
at least one memory storing instructions that, when executed by the at least one processor, cause the apparatus at least to perform:
receiving a constituent rectangle information message; and
receiving a group identifier within the constituent rectangle information message to provide a capability to group two or more constituent rectangles sharing same value for the group identifier.

9. The apparatus of claim 8, wherein when a multiview acquisition information message is present, the group identifier indicates a view identifier or determines which constituent rectangles that parameters signaled in the multiview acquisition information message apply to.
